(19) United States
(12) Patent Application Publication
(10) Pub. No.: US 2021/0018912 A1
(43) Pub. Date: Jan. 21, 2021

(54) Robot Management System

(71) Applicant: FETCH ROBOTICS, INC., SAN JOSE, CA (US)

(72) Inventors: David Tanner Dymesich, New York, NY (US); Melonee Wise, San Jose, CA (US); Nadir Muzaffar, San Jose, CA (US); Jenna Guergah, San Jose, CA (US); Russell Toris, San Jose, CA (US); Michael Ferguson, Concord, NH (US); Rodion W. Romantsov, San Jose, CA (US); Michael Hwang, San Jose, CA (US); Jiahao Feng, Castro Valley, CA (US); Justin Chen, San Jose, CA (US); Sarah Eliott, Mountain View, CA (US); Derek King, San Jose, CA (US); John W. Stewart, San Francisco, CA (US)

(73) Assignee: FETCH ROBOTICS, INC., SAN JOSE, CA (US)

(21) Appl. No.: 16/461,579

(22) PCT Filed: Apr. 10, 2019
(86) PCT No.: PCT/US2019/026854

§ 371 Date: May 16, 2019

Related U.S. Application Data
(60) Provisional application No. 62/655,744, filed on Apr. 10, 2018.
(60) Provisional application No. 62/655,756, filed on Apr. 10, 2018.

(51) Int. Cl. G05D 1/00; G05D 1/02; G06F 3/0482

(52) U.S. Cl. CPC G05D 1/0044; G05D 1/0274; G05D 1/0214; G05D 2201/0207; G05D 1/0027; G06F 3/0482; G05D 1/0225

(57) ABSTRACT

A robot management system includes: a server; a plurality of robots operably connected to the server over a network, at least one robot including a sensor; and a graphic user interface (GUI) operably connected to the server, the GUI configured to display a map of a facility comprising the plurality of robots, the map configured to receive from a user the user's instructions to manage the robot.

### PRIORITY CLAIM

The present application claims the priority benefit of U.S. provisional patent application No. 62/655,744 filed Apr. 10, 2018 and entitled “Graphic User Interface and Software for Robotic Management,” and of U.S. provisional patent application No. 62/655,755 filed Apr. 10, 2018 and entitled “System and Method for Automatically Annotating a Map,” the disclosures of which are incorporated herein by reference.

### CROSS-REFERENCE TO RELATED APPLICATIONS

This application contains subject matter that is related to the subject matter of the following applications, which are assigned to the same assignee as this application. The below-listed applications are hereby incorporated herein by reference in its entirety:

“SYSTEM AND METHOD FOR AUTOMATICALLY ANNOTATING A MAP,” by Avagyan, et al., co-filed herewith.

“SYSTEM AND METHOD FOR ROBOT-ASSISTED, CART-BASED WORKFLOW,” by Cairl, et al., co-filed herewith.

“ROBOTIC CART CONFIGURED FOR EFFECTIVE NAVIGATION AND MULTI-ORIENTATION DOCKING,” by Diehr, et al., co-filed herewith.

### SUMMARY

Embodiments of this invention relate in general to a robot management system. Other embodiments of this invention relate to a robot management system and graphic user interface (GUI). The robot management system can be used to create a map and manage a single robot. Alternatively, and additionally, and preferably, the robot management system can be used to create a map and manage a plurality of robots.

A robot management system includes: a server; a plurality of robots operably connected to the server over a network, the robot including a sensor; and a graphic user interface (GUI) operably connected to the server, the GUI configured to display a map of a facility comprising the plurality of robots, the map configured to receive from a user the user's instructions to manage the robot.

A method for robot management includes: using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, receiving, by the server, a user's Task Template, wherein the Task Template comprises a robotic workflow; receiving, by the server, a user assignment of a robot to the Task Template; presenting, by the server, to the user, an action selection menu for the Task Template; receiving, by the server, the user's selection of an action from the action selection menu for the Task Template; repeating, by the server, the step of receiving the user's selection of an action from the action selection menu for the Task Template; receiving, by the server, the user's selection of a task schedule for the Task Template; receiving, by the server, from the user a request to save the Task Template; and saving, by the server, the Task Template.

A method for robot management includes: A method for robot management, comprising: using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, receiving, by the server, a position in the facility of a facility Precision Marker; generating, by the server, a first map comprising a map Precision Marker corresponding to the facility Precision Marker; receiving, by the server, a user request to publish the first map; publishing, by the server, the first map; receiving, by the server, a user request to re-enter Edit Mode; returning, by the server, the GUI mode to the Edit Mode; waiting, by the server, while the user drives the robot in joystick mode and positions the robot in front of the fixed infrastructure; receiving, by the server, from the robot an identification of a location of the facility Precision Marker; automatically calibrating, by the server, the map Precision Marker so as to align the map Precision Marker with the facility Precision Marker; generating, by the server, a second map comprising the map Precision Marker calibration; receiving, by the server, a user request to publish the second map; and publishing, by the server, the second map.

A method for robot management includes: using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, allowing the user, by the server, to drive a robot around the facility; receiving, by the server, from the robot mapping information generated by the robot; generating a map, by the server, using the mapping information; receiving, by the server, from the user, an instruction to finish the mapping; and finishing the mapping, by the server.

### DESCRIPTION OF THE DRAWINGS

The accompanying drawings provide visual representations which will be used to more fully describe various representative embodiments and can be used by those skilled in the art to better understand the representative embodiments disclosed herein and their inherent advantages. In these drawings, like reference numerals identify corresponding elements.

FIG. 1A is a system diagram of a robot management system for managing a robot.

FIG. 1B is a wireframe of a home page for the robot management system.

FIG. 2 is a drawing of a map creation process of the robot management system.

FIG. 3 is a wireframe of an Edit Annotations page for the robot management system.

FIGS. 4A-4B are a set of two drawings of multiple users editing map annotations simultaneously using the robot management system.

FIG. 5 is a wireframe of a Preferred Route Annotation Tool page for the robot management system.

FIG. 6 is a wireframe of a Route Filter Tool for the robot management system.

FIG. 7 is a wireframe of a Survey Route Annotation Tool page for the robot management system.

FIG. 8 is a wireframe of a Robot Destination Annotation Tool page for the robot management system.

FIG. 9 is a wireframe of a Keepout Zone Annotation Tool page for the robot management system.

FIG. 10 is a wireframe of a Speed Limit Zone Annotation Tool page for the robot management system.

FIG. 11 is a wireframe of an Obstacle-Free Area Annotation Tool page for the robot management system.

FIG. 12 is a wireframe of a Charging Dock Annotation Tool page for the robot management system.

FIG. 13 is a wireframe of a Cart Transfer Location Annotation Tool page for the robot management system.

FIG. 14 is a wireframe showing configuration of a Precision Marker Annotation Tool page for the robot management system.

FIGS. 15A-15D is a series of four drawings of a user configuring a Precision Marker using an automatic calibration method of the robot management system.

FIG. 16 is a wireframe of a Text Label Tool page for the robot management system.

FIG. 17 is a wireframe of the WiFi Map tab of the robot management system.

FIG. 18 is a wireframe of the Maps page in the robot management system.

FIG. 19 is a wireframe of a Robots page for the robot management system.

FIG. 20 is a wireframe of a Devices page for the robot management system.

FIG. 21 is a wireframe of a Users page for the robot management system.

FIG. 22 is a wireframe of a Task Template page for the robot management system.

FIG. 23 is a zoomed-in wireframe of a settings popup for the robot management system.

FIG. 24 is a wireframe of a completed task template for the robot management system.

FIG. 25 is a wireframe of a Task Schedule page for the robot management system.

FIG. 26 is a wireframe of a Task Activity page for the robot management system.

FIG. 27 is a wireframe of a Maps page for the robot management system.

FIG. 28 is a wireframe of the Reset Location page for the robot management system.

FIG. 29 is a wireframe of an Analytics page for the robot management system.

FIG. 30 is a wireframe of an Analytics Error page for the robot management system.

FIG. 31 is a wireframe of a Virtual Conveyor page for the robot management system.

FIG. 32 is a wireframe of a Virtual Conveyor/Analytics page for the robot management system.

FIG. 33 is a wireframe of a Reports page for the robot management system.

FIG. 34 is a flow chart of a method for robot management.

FIG. 35 is a flow chart of a method for robot management.

FIG. 36 is a flow chart of a method for robot management.

### DETAILED DESCRIPTION

Embodiments of this invention relate in general to a robot management system. Other embodiments of the invention relate to the robot management system and graphic user interface (GUI). Embodiments of the invention provide robust management of autonomous mobile robots without a need for any sort of marker to be located in the facility to guide the robot.

As a user drives a first robot around the facility, the system creates a map of the facility. Alternatively, or additionally, as one or more users drive one or more robots around the facility, the system creates a map of the facility. For example, the map is configured to show robot activity in real time. A number of users creating the map is unlimited, and a number of robots driven by the users in creating the map is similarly unlimited. Variations are possible in which two users drive the same robot, a user drives two or more robots, and the like.

Once the user decides that the map has been completed, the user clicks a “Finish Mapping” button that terminates the mapping process.

Once a map is created by the first robot, another robot can use the same map for navigation.

Once a map is created by the first robot, all robots can use the same map for navigation.

System receives map annotations from the user to annotate the map of the facility.

The robot management system is configured to enable a user, using a graphic user interface, to perform, regarding a fleet of robots, one or more of creating a robotic workflow, scheduling a robotic workflow, changing a robotic workflow, adding a robotic station, removing a robotic station, adding a preferred route, removing a preferred route, adding a disfavored route, removing a disfavored route, adding a speed limit, removing a speed limit, adding a keepout zone, removing a keepout zone, modifying a task, modifying a robotic schedule, modifying a robot, and modifying a user.

According to embodiments of the invention, a robot management system is provided. For example, the robot management system is cloud-based. For example, the robot management system enables a user to control a robot fleet. For example, the robot management system allows the user to perform one or more of creating a robotic workflow, scheduling a robotic workflow, and changing a robotic workflow. For example, the robot management system can do one or more of add a robot destination, remove a robot destination, add a preferred route, remove a preferred route, add a disfavored route, remove a disfavored route, add a speed limit, remove a speed limit, add a keepout zone, remove a keepout zone, and the like. The GUI allows a user to perform one or more of modify an existing task, modify an existing schedule, modify a robot, and modify a user. Modifying can comprise one or more of adding, subtracting, changing, and otherwise modifying. For example, a modification is made in response to a change in one or more of a workflow and a facility.

According to embodiments of the invention, using the robot management system, a user remotely and efficiently controls a large fleet of robots.

According to further embodiments of the invention, using the robot management system, a user responds easily to changes in one or more of a facility's layout and the user's. According to yet further embodiments of the invention, the robot management system enables users to change robot workflows easily. According to yet other embodiments of the invention, the robot management system allows user changes in a robot workflow to become effective immediately.

For example, if a facility receives an unexpected delivery, using the robot management system, the user adds more robots to that scheduled task to accommodate the workload. For example, if an aisle layout changes in a customer facility, the customer, using the robot management system, uses a robot to do one or more of build a new map and annotate the map. Then within a matter of hours, all robots in the facility can be using the updated map.

According to other embodiments of the invention, the robot management system gathers in-depth analytics that inform users of the performance of not only their robot fleet, but also the human workers in their facility. According to further embodiments of the invention, the robot management system enables users to understand one or more of product flow and traffic patterns. According to other embodiments of the invention, the robot management system enables users to increase efficient use of information gathered by robots.

The Maps page is used to create a map of the user's facility and to annotate the map to help robots autonomously navigate around the facility. The Maps page also preferably but not necessarily includes sub-menus for one or more of Robots, Devices, Layers, and Groups. Once a user has finished annotating the map, the system offers the option to show the user one or more of a status of a robot on the map, a device on the map, a layer of annotations on the map, and a Position Group. The Robots menu lists robots that are using the map. The Devices menu lists all Devices that are on the map. The Layers menu lists map annotation layers individually. Each annotation type is considered a layer. For example, position comprises a layer that contains a list of positions on the map. The Groups menu shows position groups that are on the map.

A robots menu shows robots, the current status of the robots, tasks assigned, and settings. Preferably, although not necessarily, the robots menu shows all robots.

A users menu shows one or more of the name, electronic mail (email) address and account of a user. The users menu allows a user to add a new account. Preferably, although not necessarily, the users menu shows the name, email address, and account of a user. Preferably, although not necessarily, the users menu shows the name, email address, and account of each user.

A tasks menu also preferably but not necessarily includes sub-menus for one or more of task history, task schedules, and task templates.

A settings menu preferably but not necessarily includes sub-menus for one or more of charge management settings, robot settings, stage management settings, human machine interface (HMI) display settings, and general settings. Following is a brief summary of the settings.

Charge Management: To maximize battery life, the system offers the user an option to enable Charge Management Settings so robots automatically go to charge. The system offers the user an option to decide if a robot will pause a task when it needs. The system offers the user an option to decide if the robot will resume the task after charging. The system offers the user an option to decide if the robot will go to the charger after it is idle for a certain amount of time. The system offers the user an option to set a time limit for a maximum time a robot can be running without charging.

Robot Settings: The settings page also enables users to change global settings that apply to their fleet of robots. The system offers the user an option to define a Time Zone Region for their facility. The system offers the user an option to set one or more of a maximum robot speed a robot will travel, a maximum data survey robot speed during a data survey, and a maximum robot turn speed during a turn of the robot. The system offers the user an option to decide if the robot plays sound during navigation.

Stage Management Settings: The system offers the user an option, when a robot has finished a task and has no new task assigned, to instruct the system to return the robot to a staging area set up on the map with positions. Stage Management Settings allow the system to offer the user an opportunity to select an amount of idle time before the system sends the robot to a staging area.

HMI Display Settings: The robot HMI screen displays a web URL. This is, by default, a web page that the system allows the user to customize using the Task Templates. To change this display, the system offers the user an option to go to HMI Display Settings and enter a URL in an “Enter URL” field to set the HMI display.

A Reports menu shows report templates that allow a user to set up a report about robot performance statistics. For example, the Reports menu shows report templates that allow the user to set up an automatically generated report about robot performance statistics.

For example, the server allows the user, using the GUI, to create a map of the user's facility so that robots can transport materials around the user's facility effectively. For example, the server allows the user to set up an area comprising one or more of a Speed Limit Zone, a Keepout Zone, and an Obstacle-Free Area. For example, the server allows the user to set up a traffic rule for robots traveling around the user's facility. For example, the server allows the user to do one or more of configure and monitor a robot. For example, the user can monitor which robots have the right of way on a given route.

For example, the server allows the user to distribute a task to a robot. For example, the server allows the user to modify one or more of a robotic task and a robotic schedule. For example, the server allows the user to set up a dock station to maintain a robot's charge level. For example, the server gives the user secure access to the robot management system from one or more of a computer and a mobile device.

When the user logs into the robot management system for the first time and navigate to the Maps tab, a “Build New Map” button in the middle of the screen prompts the user to create a map. Then, the system prompts the user to select which robot they will use to build the map and click “Start Mapping.”

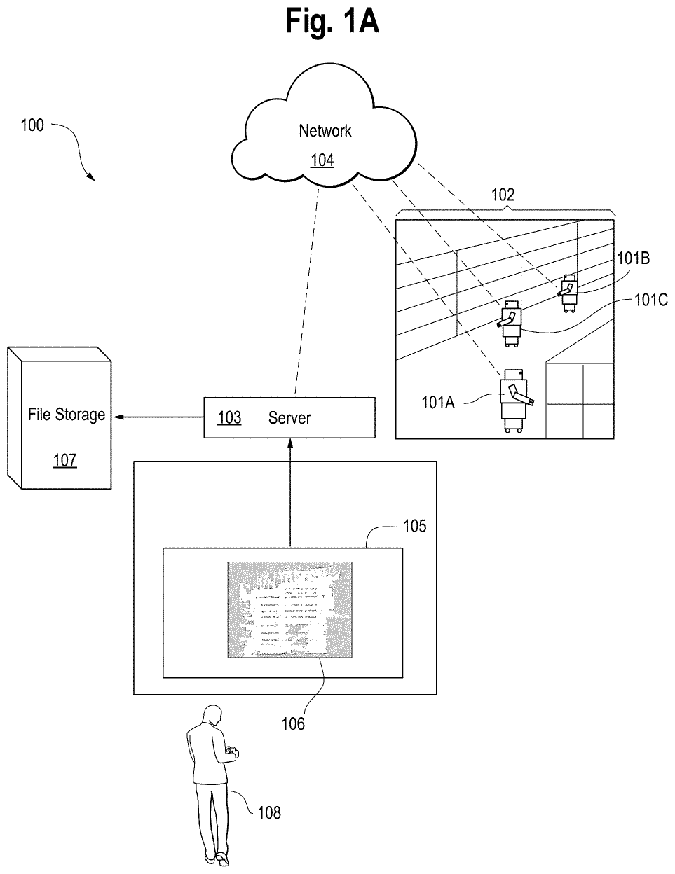

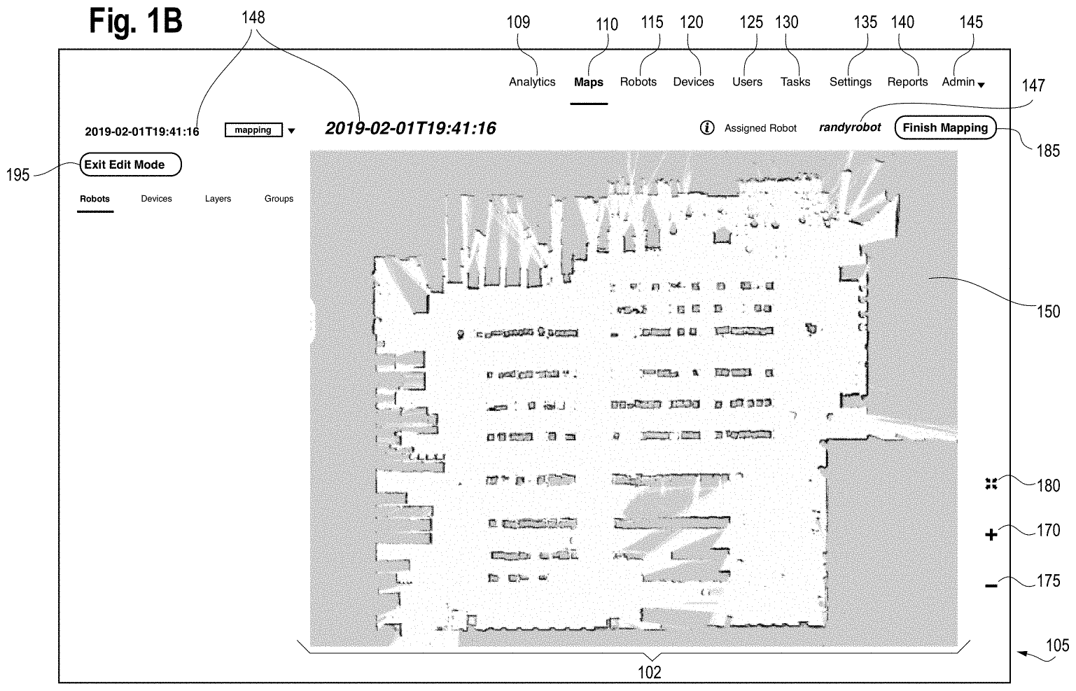

FIG. 1A is a system diagram for a robot management system 100 for managing a robot. The system 100 comprises a plurality of robots 101A, 101B, and 101C operating in a facility 102, a server 103 operably connected to each of the plurality of robots 101A-101C over a network 104, a graphic user interface (GUI) 105 operably connected to the server 103, the GUI displaying a map 106 of the facility 102, and file storage 107 operably connected to the server 103. Also depicted is a human user 108. The server 103 is also operably connected to the GUI 105 usable by the human 108 to do one or more of view a map 106 of the facility 102 and edit the map 106 of the facility 102.

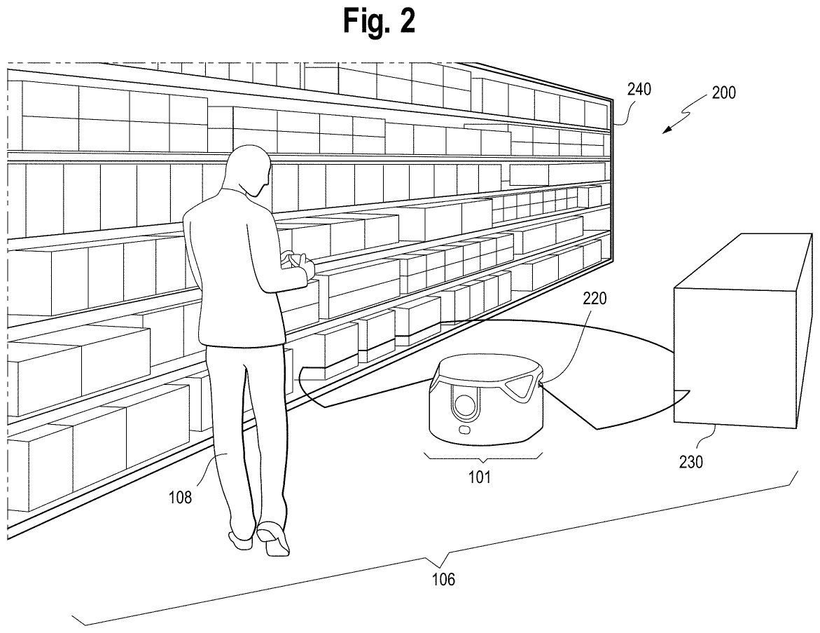

FIG. 1B is a wireframe of a home page 100 for the robot management system. The system opens a home page 100 as depicted in FIG. 1. A user (not shown) selects a robot 101. The system starts building a map 106 using the robot 101 and opens the home page 100. The robot 101 comprises a sensor (not shown in this figure). For example, the sensor comprises a Lidar and 3D depth image camera. The robot 101 can see objects with its sensor and builds a map 106 as a user (not shown; this user can either be the same or different from the previously mentioned user) drives the robot 101 around a facility 102 using a controller (not shown in FIG. 1; discussed below in more detail in FIG. 2). As the user drives the robot 101 around the facility, a black and white map of the facility is created.

The home page 100 comprises the map 106 of the facility 102. For example, the facility 102 comprises a warehouse. After a user logs into the system, the user is presented with the map 106 of the facility 102. The system displays an unmapped area 150 in grey on the map 106 of the facility 102. The system represents a sensed object 155 in black on the map 106 of the facility 102. For example, the sensed object 155 comprises one or more of an obstacle, a shelf, and a wall. The system represents an open space 160 that is known to be unoccupied by the robot as white on the map 106 of the facility 102.

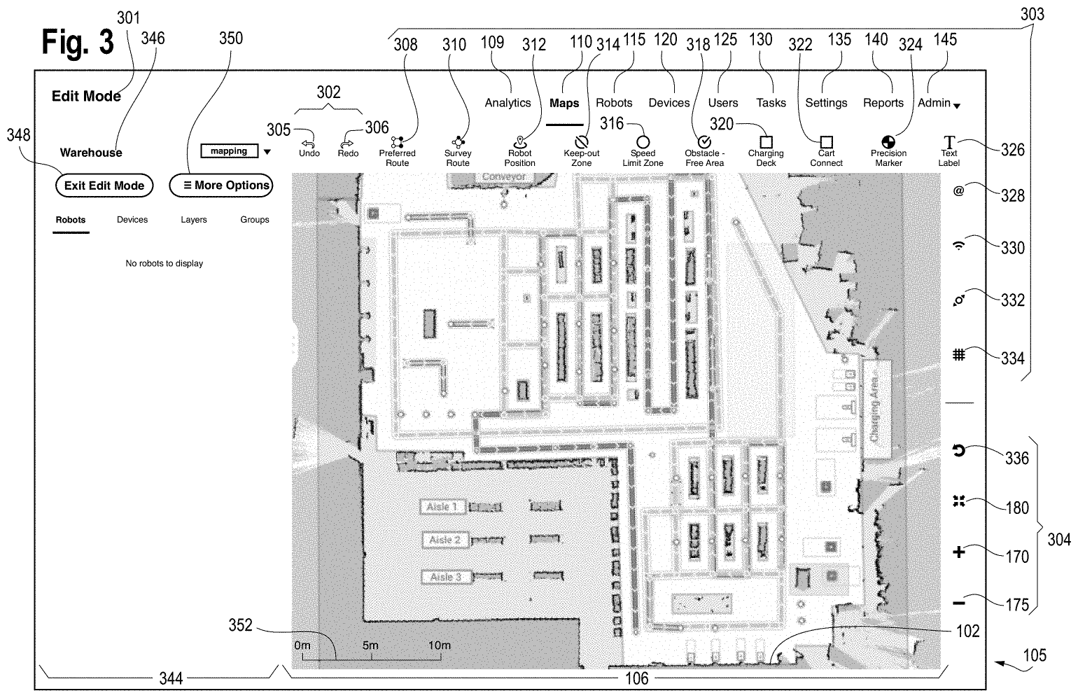

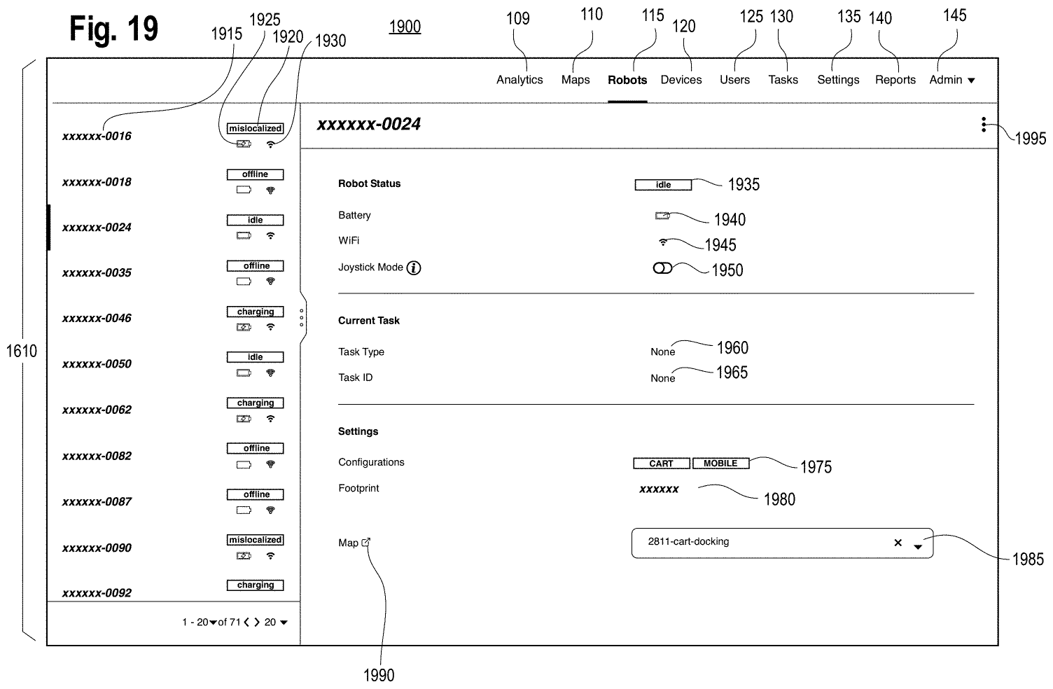

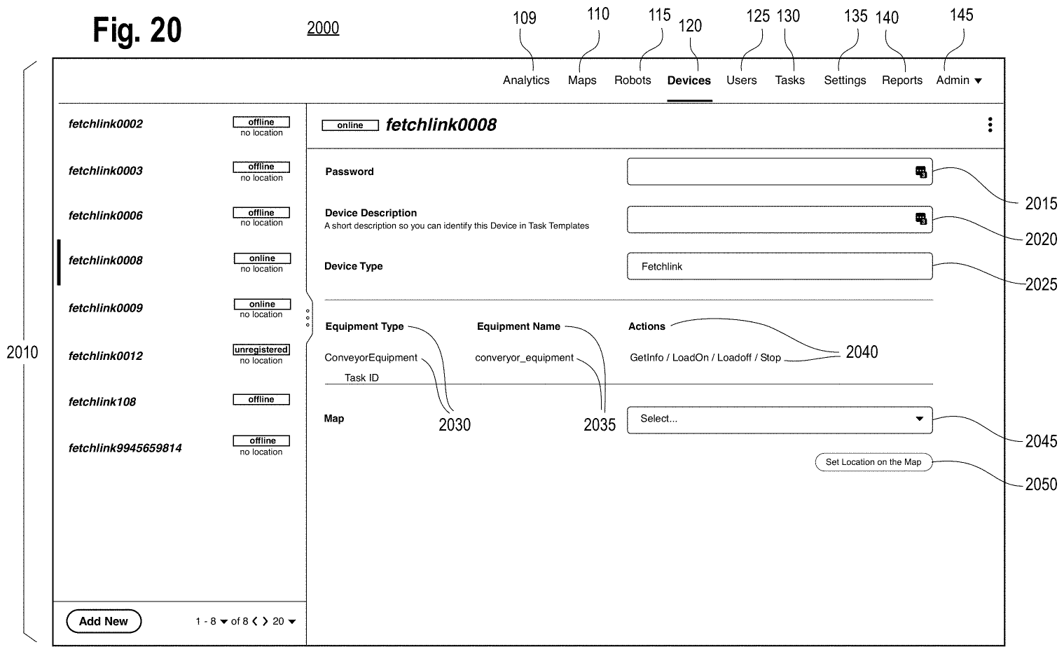

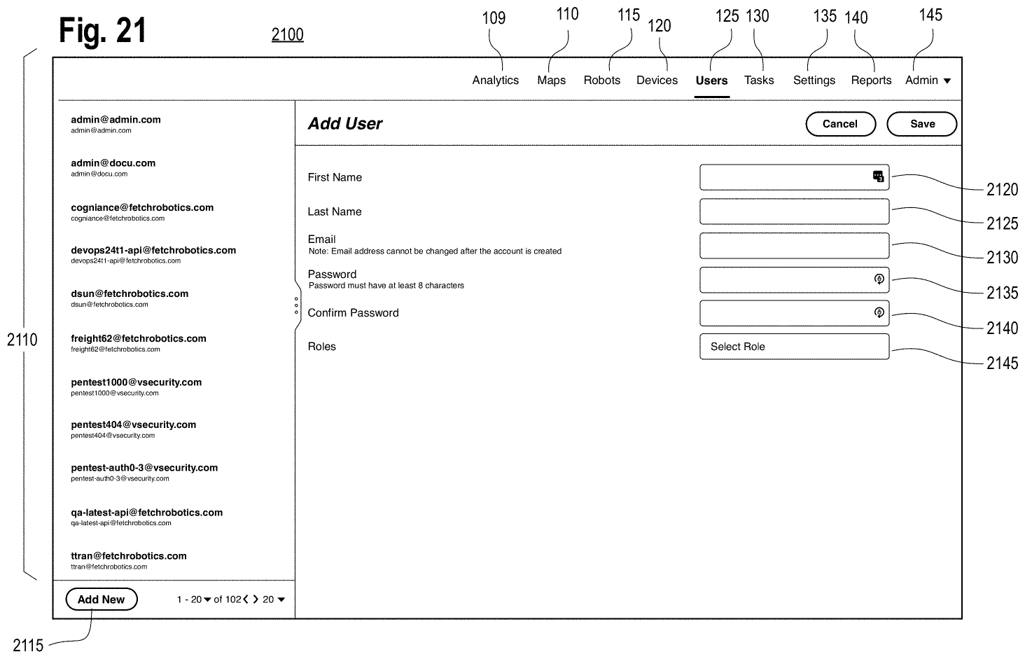

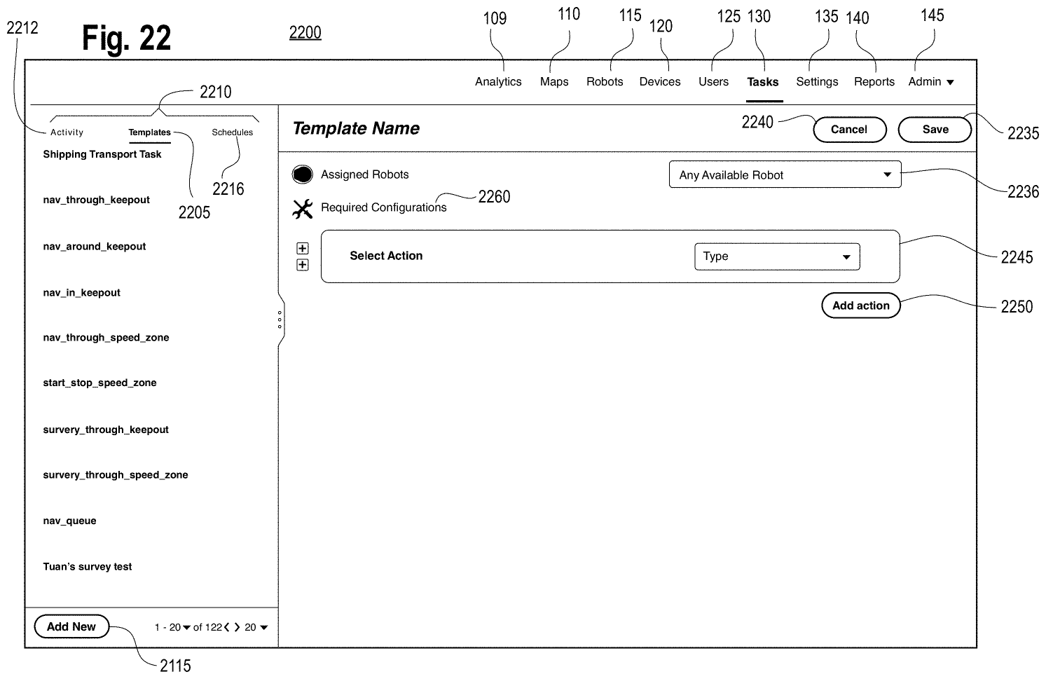

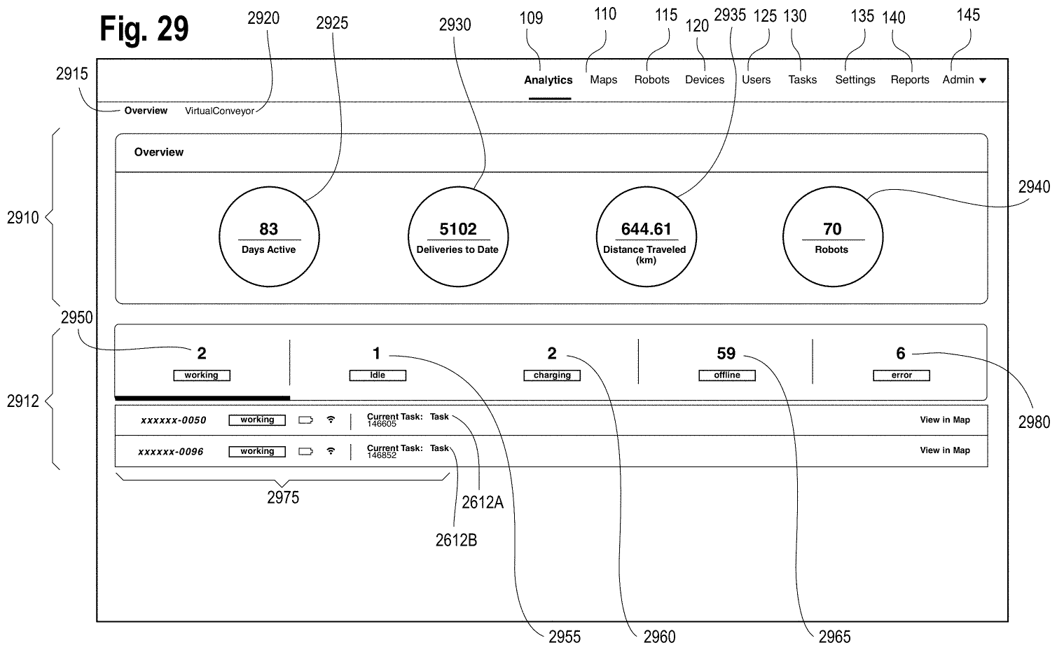

The home page 100 further comprises an Analytics tab 109, a Maps tab 110, a Robots tab 115, a Devices tab 120, a Users tab 125, a Tasks tab 130, a Settings tab 135, a Reports tab 140, an Admin tab 145, a robot ID 147, and a map name 148. The Analytics tab 109 (discussed below in more detail in FIG. 29) comprises one or more of analytics information and analytics options available to the user. The Maps tab 110 (discussed below in more detail in FIGS. 3-18 and FIG. 27) comprises one or more of map information and map options available to the user. The Robots tab 115 (discussed below in more detail in FIG. 19) comprises one or more of robot information and robot options available to the user. The Devices tab 120 (discussed below in more detail in FIG. 20) comprises one or more of device information and device options available to the user. The Users tab 125 (discussed below in more detail in FIG. 21) comprises one or more of user information and user options available to the user. The Tasks tab 130 (discussed below in more detail in FIG. 22-26) comprises one or more of task information and task options available to the user. The Settings tab 135 comprises one or more of setting information and setting options available to the user. The Reports tab 140 comprises one or more of email report information and email report options available to the user. The Admin tab 145 comprises one or more of administrative information and administrative options available to the user. If a user clicks on the Admin tab 145, the system opens a dropdown menu with the following options: A Profile link takes users to their account information on the Users page 125. An About option opens a popup containing a software version. A Status link opens a popup with System Uptime, Server Uptime and Coordinator Uptime. A Documentation link takes users to the user guide for the robot management system. Lastly, a Sign Out link will log users out off the robot management system.

The robot ID 147 identifies the robot 101 that is currently mapping. The map name 148 comprises a name of the map 106. For example, the user can select the map name 148 that, relative to the map creation date/time, is something that is one or more of more specific and more meaningful. For example, the user can select the map name 148 after the mapping process is completed. Alternatively, or additionally, the user can select the map name 148 before the mapping process is completed. If the user does not select the map name 148, the system selects as a default for the map name 148 the map creation date/time.

To change the map 106, the user can use one or more of a Zoom In button 170, a Zoom Out button 175 and a Fit to Page button 180. The Zoom In button 170 is configured to provide the user with a map 106 showing a closer view. The Zoom Out button 175 is configured to provide the user with a map 106 showing a farther view. The Fit to Page button 180 is configured to provide the user with a map 106 that is shown in full and is fitted to the home page 100.

Once the user decides that the map has been completed, the user clicks a “Finish Mapping” button 185. Upon receipt of the user's click of the “Finish Mapping” button, the system terminates the mapping process. Once a map is created by the robot 101, another robot 101 can use the same map for navigation. Alternatively, or additionally, once a map is created by the robot 101, all robots 101 can use the same map for navigation. Alternatively, or additionally, once the map is created, another robot 101 comprising a similar type of base can use the same map for navigation. Alternatively, or additionally, once the map is created, all robots 101 comprising a similar type of base can use the same map for navigation.

FIG. 2 is a drawing 200 of a map creation process of the robot management system. A user 106 drives a robot 101 around the facility 102. The robot 101 comprises a sensor 220. For example, the sensor 220 comprises a laser sensor. For example, the sensor 220 comprises a radio frequency identification (RFID) sensor. The facility 102 further comprises an obstacle 230 and a shelf 240. The sensor 220 detects the obstacle 230 and builds a map (not shown in this figure) as seen in FIG. 1.

Now, the system is ready to receive map annotations from the user 106. The system invites the user 106 to click an “Edit Annotations” button 195. The system then takes the user 106 to an Edit Annotations page 300 shown in FIG. 3.

FIG. 3 is a wireframe of an Edit Annotations page 300 for the robot management system. The Edit Annotations page 300 again comprises the map 106 of the facility 102. The system places the user in Edit Mode and displays an Edit Mode legend 301 in an upper left-hand corner of the screen. The system presents the user with the Edit Annotations page 300 so that the system can receive a user annotation. For example, the user annotation comprises one or more of navigation information and workflow information. For example, the user annotation comprises one or more of navigation information usable by the robot and workflow information usable by the robot.

The Edit Annotations page 300 comprises map editing tools 301, map Annotation Tools 302, and map viewing tools 303. The map editing tools 301 are usable by the user to edit the map 106. The map editing tools 302 comprise an “Undo” button 305 and a “Redo” button 306. The “Undo” button 305 allows a user to undo the most recent edit made to the map 302. The “Redo” button 306 allows a user to re-implement a change after a user has undone it using the “Undo” button 305.

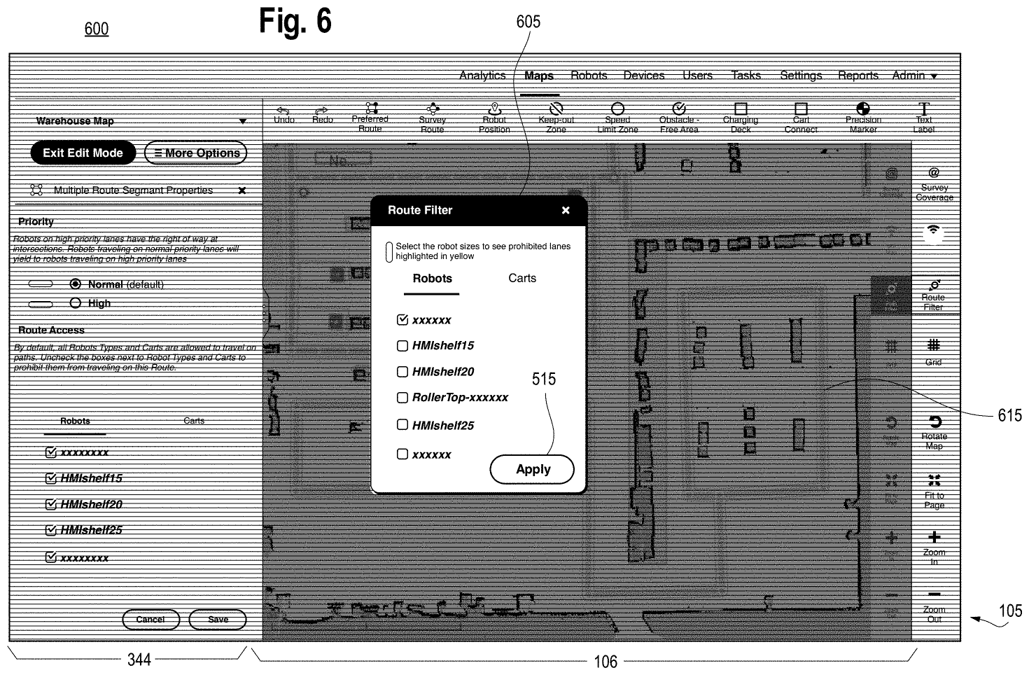

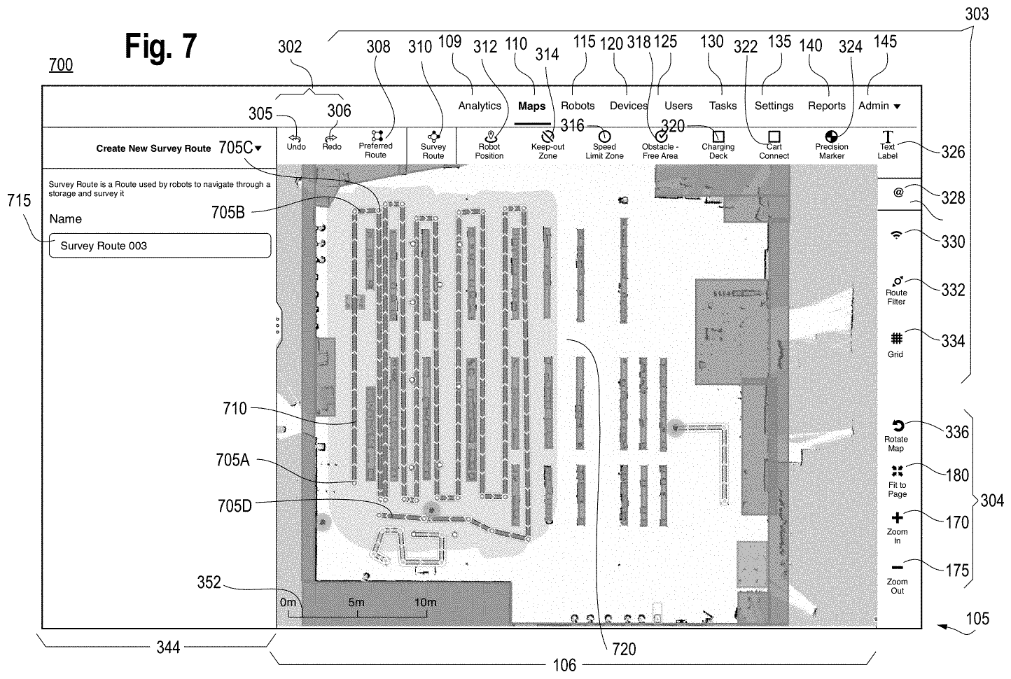

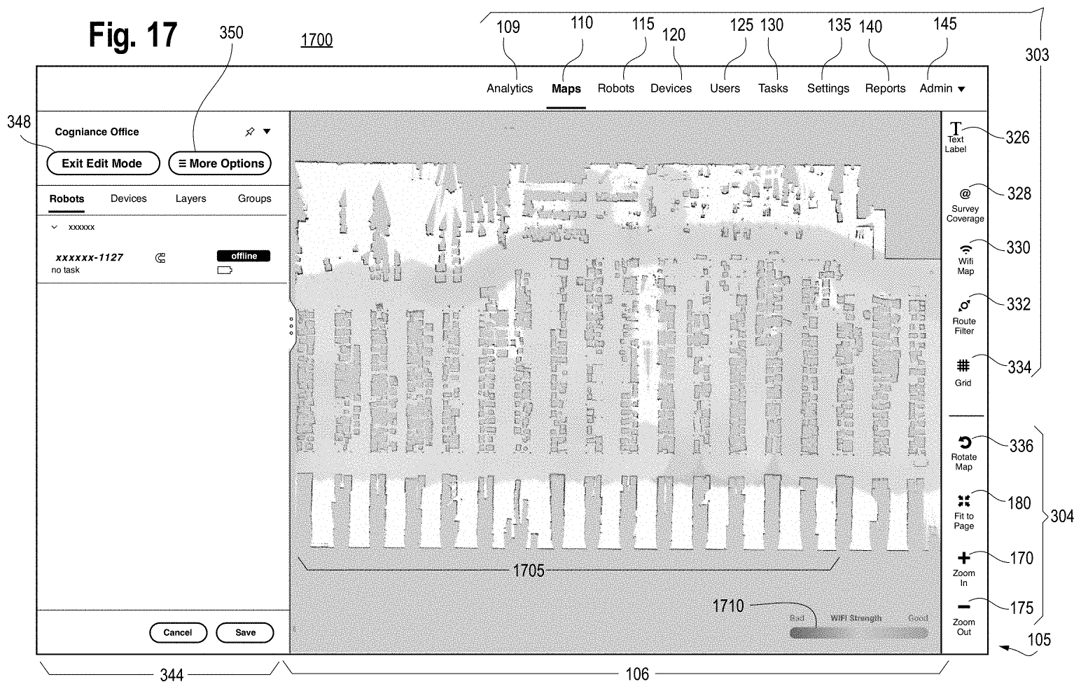

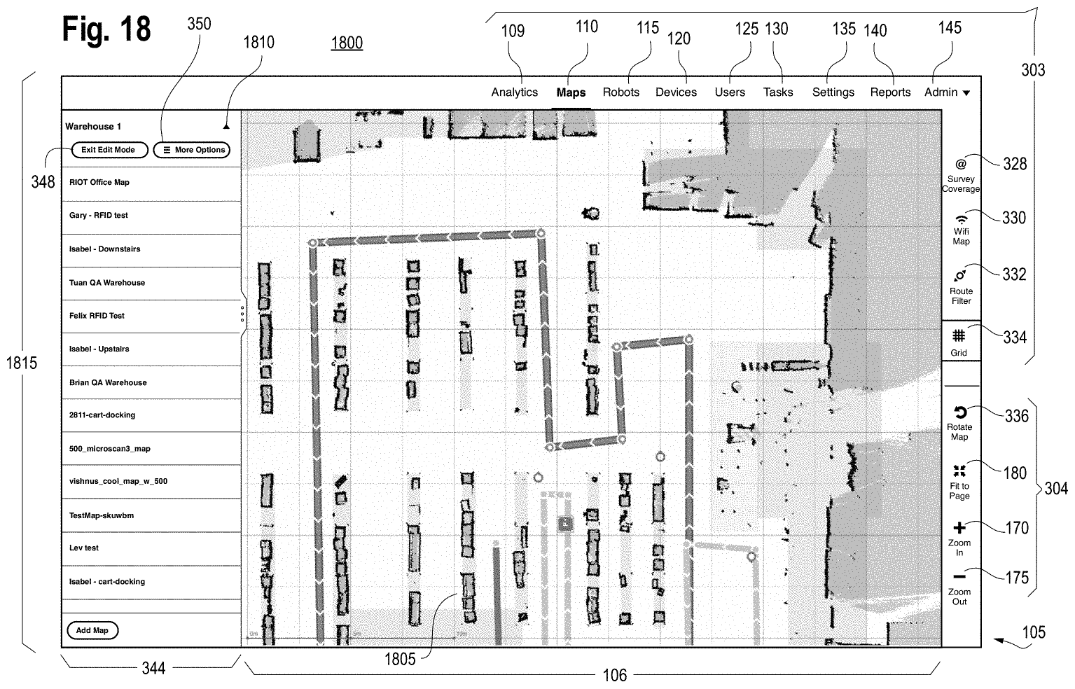

The map Annotation Tools 303 are selectable by the user to annotate the map 106 of the facility 102. The map Annotation Tools 303 comprise a Preferred Route tab 308, a Survey Route tab 310, a Robot Destination tab 312, a Keepout Zone tab 314, a Speed Limit Zone tab 316, an Obstacle-Free Area tab 318, a Charging Dock tab 320, a Cart Transfer tab 322, a Precision Marker tab 324 a Text Label tab 326, a Show Survey Coverage tab 328 (discussed below in more detail in FIG. 7), a WiFi Map tab 330 (discussed below in more detail in FIG. 17), a Route Filter tab 332 (discussed below in more detail in FIG. 6), and a Show Grid tab 334 (discussed below in more detail in FIG. 18). The Show Survey Coverage tab 328, the WiFi Map tab 330, the Route Filter tab 332, and the Show Grid tab 334 are all overlay tools as discussed below in more detail.

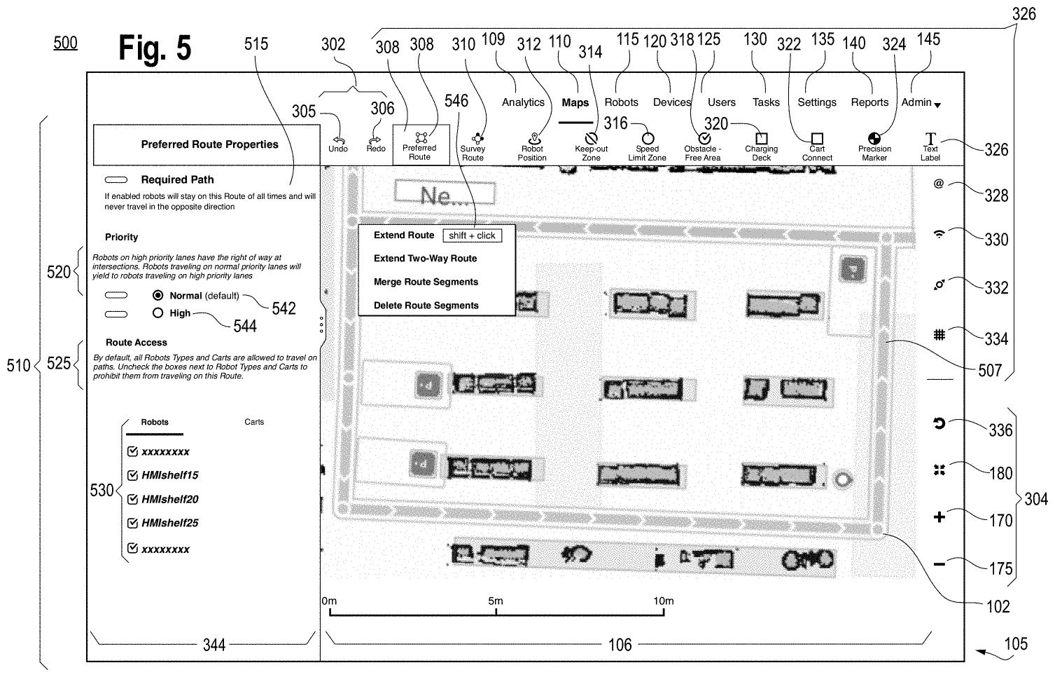

The Preferred Route tab 308 (discussed below in more detail in FIG. 5) comprises one or more of information pertaining to a preferred robotic route and information pertaining to a Preferred Route for a cart. While adding Preferred Routes in the map annotation process, a user selects one or more of which robots 101 are allowed to access which routes, and which carts are allowed to access which routes. For example, while adding a Preferred Route in the map annotation process, a user selects one or more of which types of the robot are allowed to access which routes, and which cart types are allowed to access which routes. This information is used later by the Route Filter tab 332 (discussed below in more detail in FIG. 6).

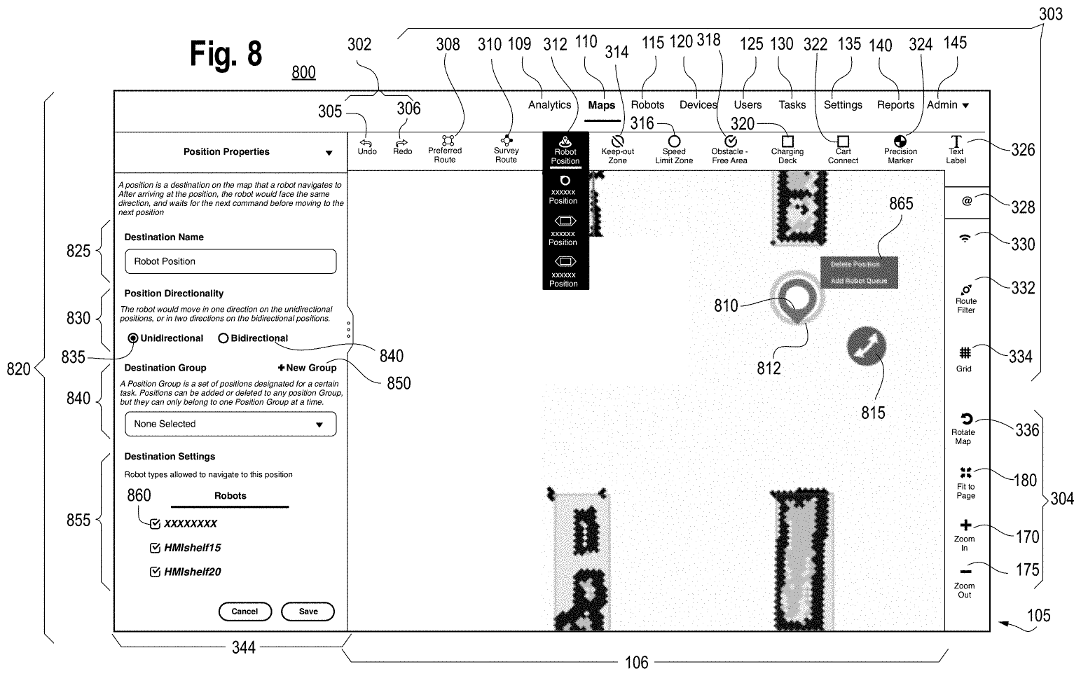

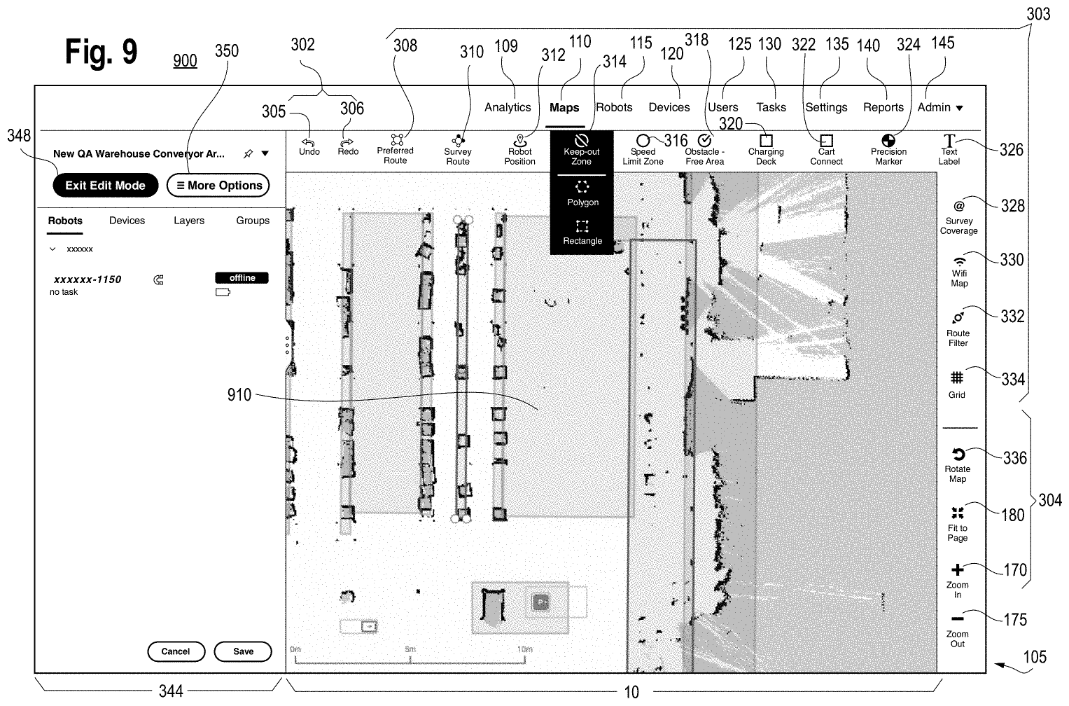

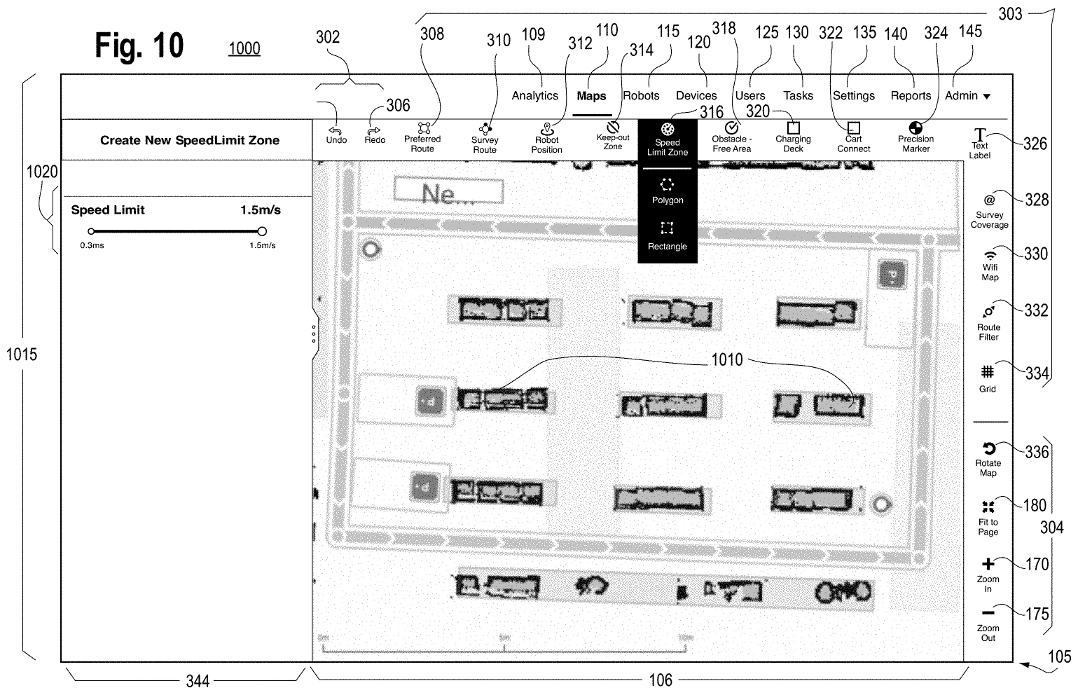

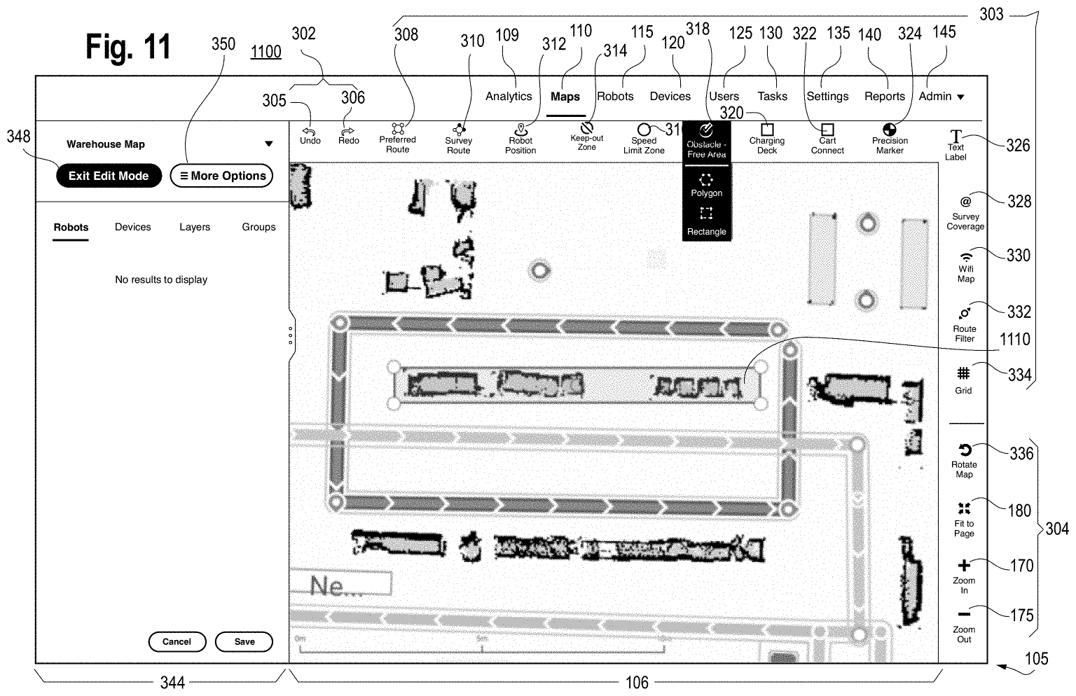

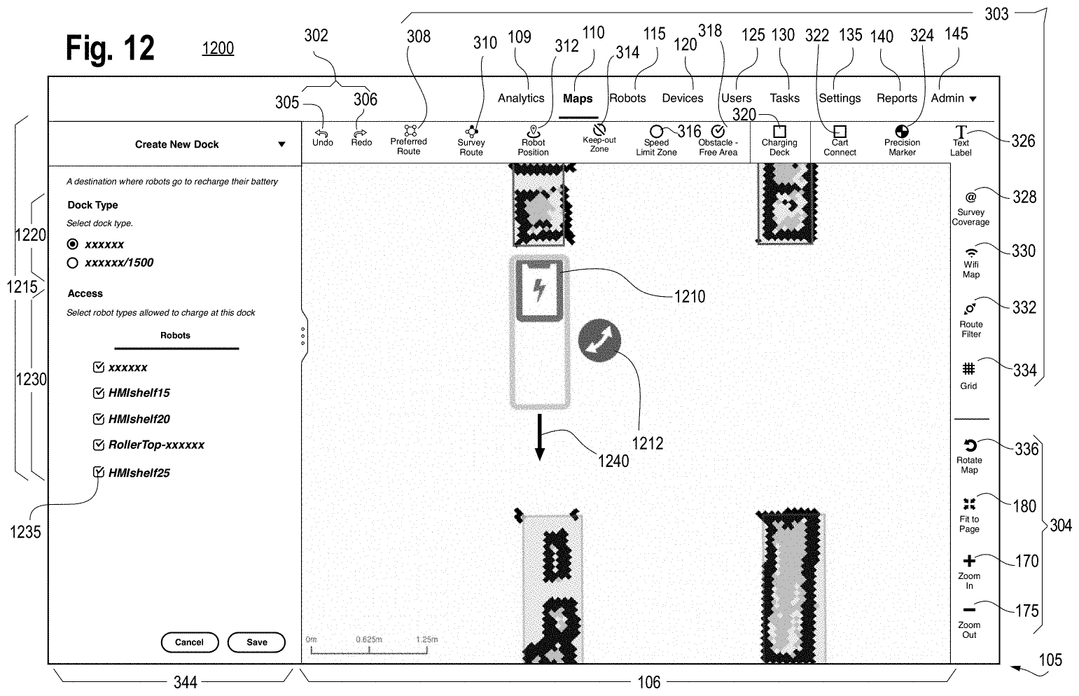

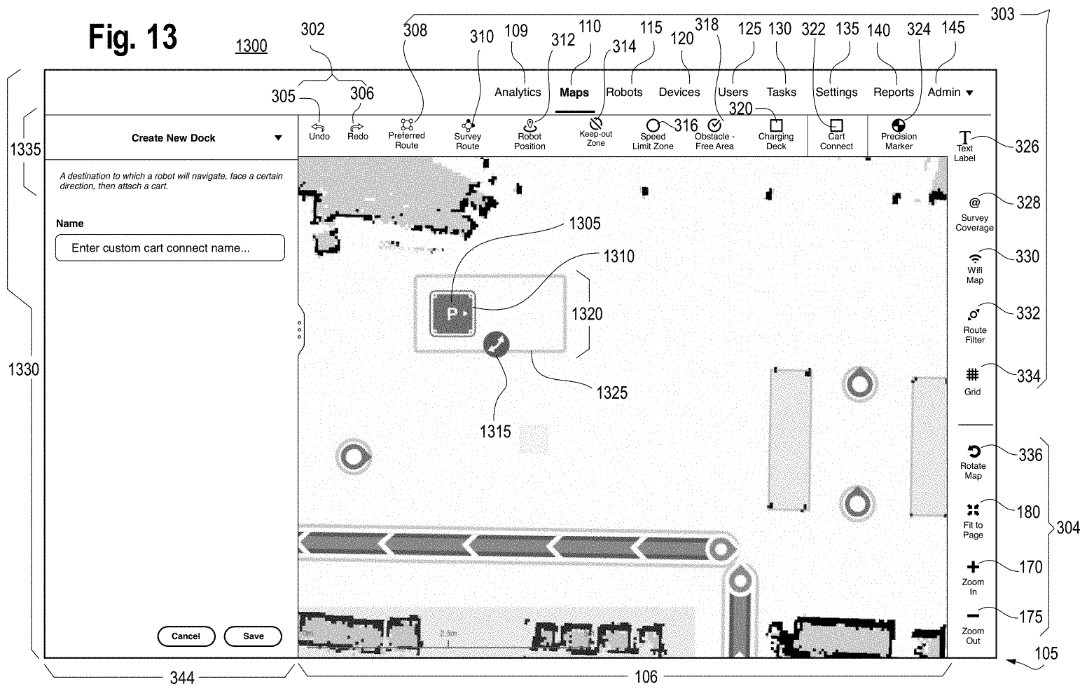

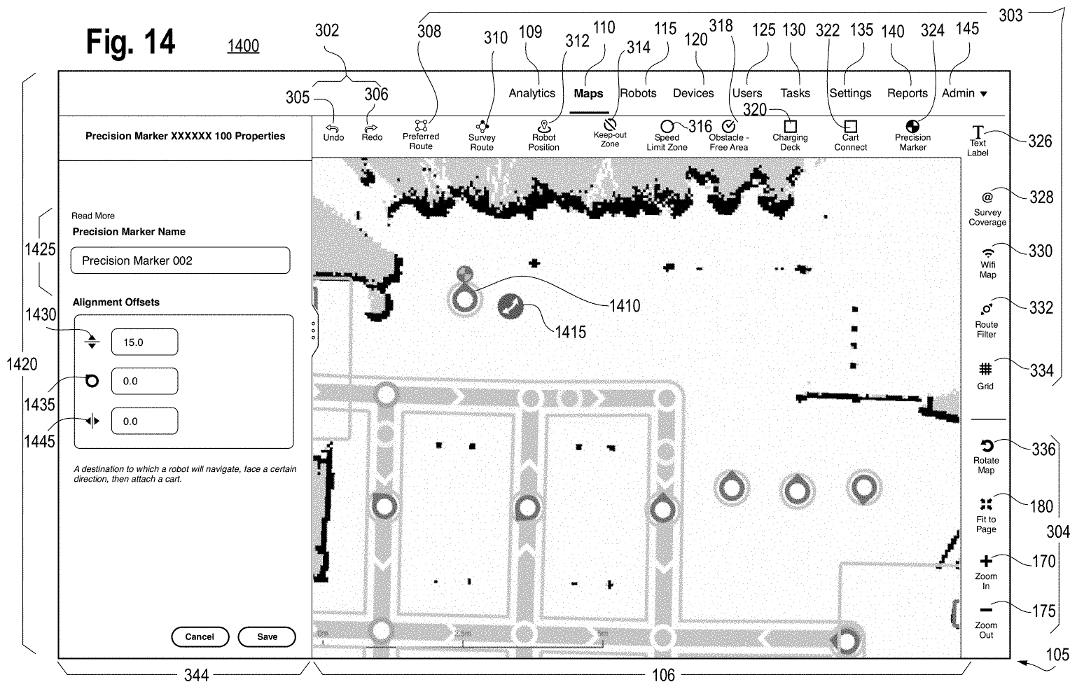

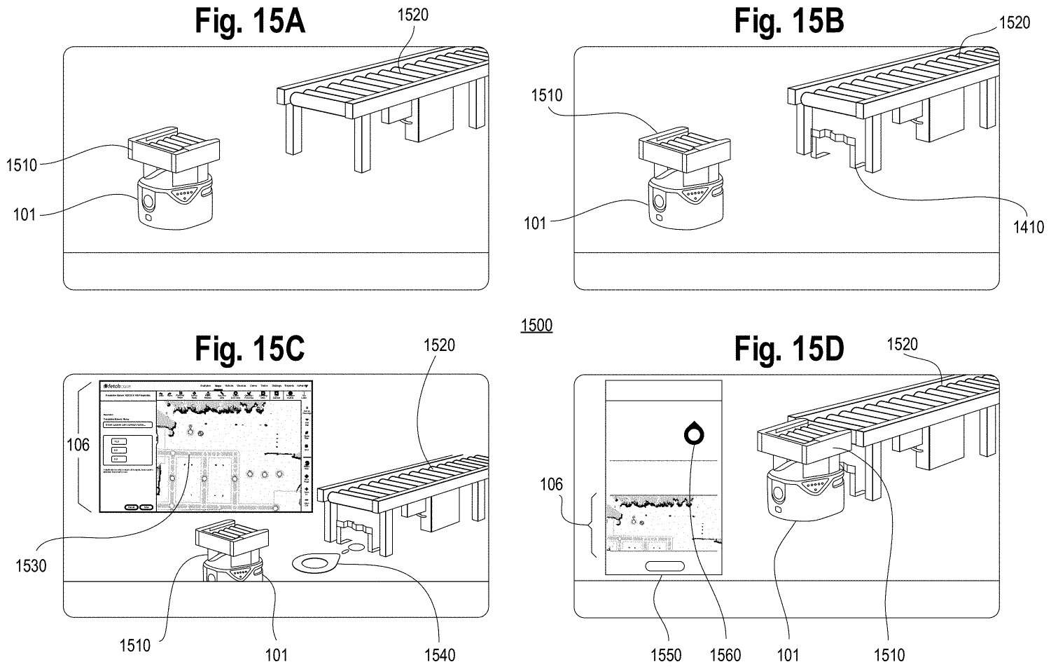

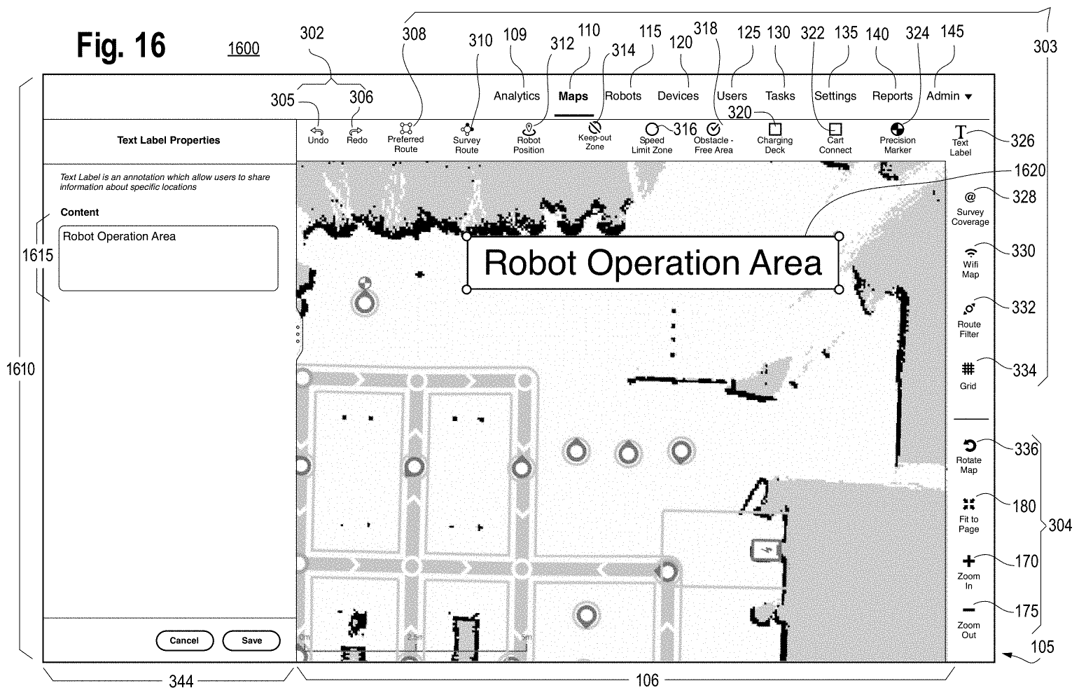

The Survey Route tab 310 (discussed below in more detail in FIG. 7) comprises one or more of Survey Route information and Survey Route options available to the user. The Robot Destination tab 312 (discussed below in more detail in FIG. 8) comprises one or more of robot information and robot options available to the user. The Keepout Zone tab 314 (discussed below in more detail in FIG. 9) comprises one or more of Keepout Zone information and Keepout Zone options available to the user. A Keepout Zone refers to an area that is unavailable to the robot. The Speed Limit Zone tab 316 (discussed below in more detail in FIG. 10) comprises one or more of Speed Limit Zone information and Speed Limit Zone options available to the user. A Speed Limit Zone refers to an area in which the system, based on one or more of a system default, a system algorithm, and a user instruction, instructs the robot that it has one or more of a minimum speed of travel and a maximum speed of travel. The Obstacle-free Area tab 318 (discussed below in more detail in FIG. 11) comprises one or more of Obstacle-Free Area information and Obstacle-Free Area options available to the user. An Obstacle-Free Area refers to an area not comprising an obstacle that interferes with the robot's navigation. The Charging Dock tab 320 (discussed below in more detail in FIG. 12) comprises one or more of Charging Dock information and Charging Dock options available to the user. The Cart Transfer tab 322 (discussed below in more detail in FIG. 13) comprises one or more of Cart Transfer information and Cart Transfer options available to the user. The Precision Marker tab 324 (discussed below in more detail in FIGS. 14-15) comprises one or more of Precision Marker information and Precision Marker options available to the user. The Text Label tab 326 (discussed below in more detail in FIG. 16) comprises one or more of Text Label information and Text Label options available to the user.

The Show Survey Coverage tab 328 upon selection by the user provides a Coverage overlay to the map 106 of the facility 102 showing an estimated coverage region that the sensors of the robot will read while traveling on a data Survey Route (discussed below in more detail in FIG. 7).

The WiFi Map tab 330 upon selection by the user provides a WiFi overlay to the map 106 of the facility 102 showing an estimated connectivity strength of a WiFi network (discussed below in more detail in FIG. 17).

The Route Filter tab 332 (discussed below in more detail in FIG. 6) upon selection by the user provides a Route Filter overlay to the map 106 of the facility 102 showing a route that is prohibited for one or more of the selected robot and the selected cart.

If a user restricts a robot from using a Preferred Route, the Route Filter tab 332 allows the user to select the type of robot that is restricted. If a user restricts a cart from using a Preferred Route, the Route Filter tab 332 allows the user to select the type of cart that is restricted. For example, the system highlights Preferred Routes from which one or more of a robot and a cart is restricted.

The Show Grid tab 334 upon selection by the user provides a Grid overlay (not shown) to the map 106 of the facility 102. The Grid overlay displays orthogonal gridlines to assist the user in drawing straight lines during map annotation (discussed below in more detail in FIG. 18).

The map viewing tools 304 are usable by the user to view the map 106. The map viewing tools 304 comprise a Rotate Map button 336, the Zoom In button 170, the Zoom Out button 175, and the Fit to Page button 180. The Rotate Map button 336 if pressed by the user will rotate an orientation of the map 106. The Zoom In button 170 is again configured to provide the user with a map 106 showing a closer view. The Zoom Out button 175 is again configured to provide the user with a map 106 showing a farther view. The Fit to Page button 180 if pressed by the user will provide the user with a map 106 that is shown in full and is fitted to the Edit Annotations page 300.

The Edit Annotations page 300 further comprises an Annotations sidebar 344. As shown, the Annotations sidebar 344 comprises a Map Name button 346, an “Exit Edit Mode” button 348, a “More Options” button 350, and a map scale 352. The Map Name button 346 displays a name of the current map. The Map Name button 346 if pressed by the user opens a drop-down menu comprising other created maps. For example, the Map Name button 346 if pressed by the user opens a drop-down menu comprising all other created maps (discussed below in more detail in FIG. 18).

After the user has fully annotated the map, they click the “Exit Edit Mode” button 348. When the user clicks the “Exit Edit Mode” button 348, a popup opens that warns of the importance of reviewing proposed map changes for safety and accuracy. An “Exit Draft” button allows the user to leave Edit Mode without sending map changes to the robots 101. A “Publish” button allows the user to leave the Edit Mode and apply the changes to all robots 101 using the map.

If the user presses the “More Options” button 350, the system displays actions available to the user. In the “More Options” drop-down, the user can Delete Map, Duplicate Map, Pin Map, Unpin Map or Build New Map. If the user chooses the “Delete Map” option, the system deletes the map 106. If the user chooses the “Duplicate Map” option, the system makes a copy of the map. If the user chooses the “Pin Map” option, the system sets a default to open to that map. If the user chooses the “Unpin Map” option, the system will no longer open to that map by default. If the user chooses the “Build New Map” option, the system starts the map building process outlined in FIG. 1. If the system comprises more than one map, the user can click an arrow 350 next to the current map name to open a dropdown menu containing all maps. Clicking on a map name will open that map in the main window.

The map scale 352 displays a relationship between distance on the map 106 and a corresponding distance on the ground. For example, the map scale 352 displays a ratio of the distance on the map 106 and the corresponding distance on the ground. For example, the map scale 352 comprises a ratio of 120 to one, meaning that ten feet on the ground corresponds to one inch on the map 106. The map scale 352 displays a value that changes depending on a zoom level of the map, and therefore the map scale 352 displays a value that changes based on a user's use of one or more of the Zoom In button 170 and the Zoom Out button 175.

Error Handling: To assist the user in annotating their map, a new annotation is marked if the new annotation conflicts with an existing annotation. For example, if a user proposed a new annotation to place a Robot Destination in a position designated as a Keepout Zone, the user receives a red error message. Optionally, the system also marks the existing annotation. For example, the system marks the new annotation in red. For example, the system optionally marks the existing annotation in one or more of red and another color.

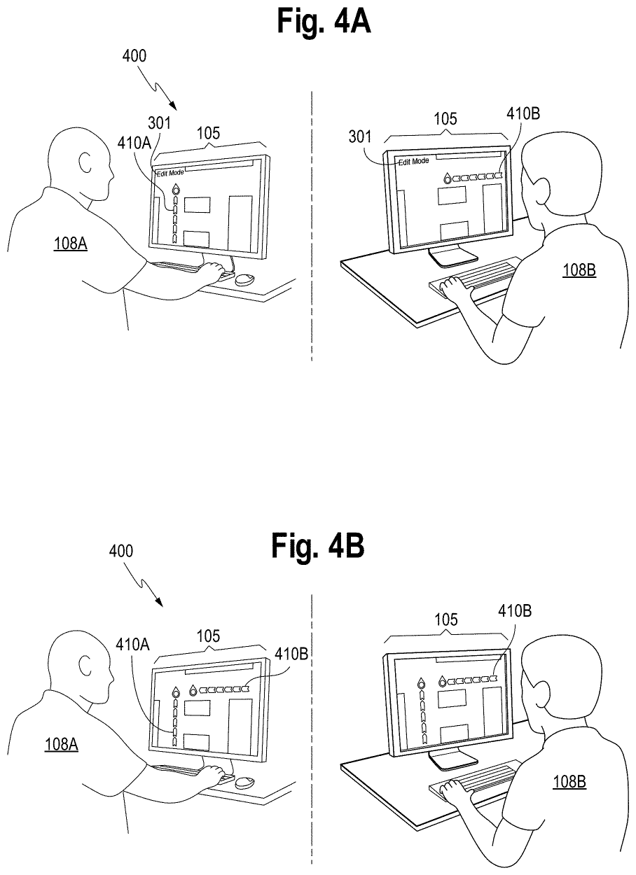

FIGS. 4A-4B are a set 400 of two drawings of multiple users editing map annotations simultaneously using the robot management system (FIG. 4A) and then of multiple users viewing the edited map in Published Mode (FIG. 4B). The system is configured to simultaneously receive different annotations from multiple users. A user can see an annotation submitted by another user after exiting Edit Mode.

In FIG. 4A, a first user 106A uses a first computer 420A to annotate a map 106. As discussed above with reference to FIGS. 1-3, the first user 106A presses the “Edit Annotations” button 195 to proceed to the Edit Annotations page 300 shown in detail in FIG. 3. The first user is then in the Edit Mode 301. As discussed above with reference to FIGS. 1-3, the first user 106A presses the “Edit Annotations” button 195 to proceed to the Edit Annotations page 300 shown in detail in FIG. 3. The first user 106A creates a first annotation 410A.

Similarly, a second user 106B uses a second computer 420B to annotate the map 106. Similarly, as discussed above with reference to FIGS. 1-3, the second user 106B presses the “Edit Annotations” button 195 to proceed to the Edit Annotations page 300 shown in detail in FIG. 3. The second user is then in the Edit Mode 301. In order to make annotations, the second user 106B works in Edit Mode. The second user 106B creates a second annotation 410B. In the Edit Mode 301, the second user 106B is unable to see the first annotation 410A made by the first user 106A. Similarly, in the Edit Mode 301, the first user 106A is unable to see the second annotation 410B made by the second user 106B.

In FIG. 4B, the first user 106A has completed the first annotation 410A and has exited Edit Mode by pressing the “Exit Edit Mode” button 348 discussed in FIG. 3. Similarly, the second user 106B has completed the second annotation 410B and has exited Edit Mode by pressing the “Exit Edit Mode” button 348 discussed in FIG. 3. The first user 106A is able to see both the first annotation 410A made by the first user 106A and the second annotation 410B made by the second user 106B. Similarly, the second user 106B is able to see both the first annotation 410A made by the first user 106A and the second annotation 410B made by the second user 106B.

FIG. 5 is a wireframe of a Preferred Route Annotation Tool page page 500 for the robot management system. Preferred Routes are the Preferred Routes that the robots 101 use to travel around the facility 102. If the user selects the map Annotation Tool Preferred Route tab 308 from the Edit Annotations page 300 as shown in FIG. 3, the system receives the user's selection and presents the user with the Preferred Route page 500.

The Preferred Route page 500 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352.

To add a Preferred Route to the map 106 of the facility 102, the user clicks on the map 106 to draw a Preferred Route 307. A Preferred Route 307 is one or more of unidirectional and bidirectional. A Preferred Route 307 that is unidirectional permits the robot to travel on it only in a specified direction. A Preferred Route 307 that is bidirectional permits the robot to travel on it in either direction. If a Preferred Route is obstructed, the robots 101 will exit the route and autonomously navigate to a destination.

The Preferred Route page 500 further comprises a Preferred Route sidebar 510. The Preferred Route sidebar 510 offers the user options to configure settings relating to the Preferred Route 507. The Preferred Route sidebar 510 comprises a Required Route toggle button 515, Route Priority buttons 520, a Route Access legend 525, a Robot Permissions menu 530, and a Preferred Route overlay 540.

The Required Route toggle button 515 when selected by the user requires the robot to strictly follow the Preferred Route 507 during autonomous navigation and requires the robot not to travel in an opposite direction on the Preferred Route 507. The Route Priority buttons 520 allow a user to set a priority of a Preferred Route 507. For example, and as shown, the user can select a priority as one of more of “low,” “normal (default)” 542 and “high” 544. The user can also select a low priority (not shown) if a robot traveling on the low priority route will not have a right of way at intersections, relative to a robot traveling on a route that is not low priority. The user can set the Preferred Route 507 to high priority, which means that a robot traveling on the high priority route will have a right of way at intersections, relative to a robot traveling on a route that is not high priority.

The Route Access legend 525 advises the user to specify one or more of a type of robot and a type of cart authorized to travel on the Preferred Route 507. As depicted, the Route Access legend comprises text reading: “By default, all Robot Types and Carts are allowed to travel on Preferred Routes. Uncheck the boxes next to Robot Types and Carts to prohibit them from traveling on this route.” By default, all robots 101 and carts are allowed to travel on the Preferred Route 507. To disallow a robot or cart from traveling on the route, the user simply clicks on a checkbox 546 next to one or more of a type of robot and a type of cart to deselect it. The user can define all of these settings before drawing a Preferred Route 507 on the map 106 so that all segments have desired settings.

The system invites the user to select a Preferred Route directionality for the Preferred Route 507. The system invites the user to click a unidirectional option if the user desires to select a unidirectional directionality for the Preferred Route 507. The unidirectional option 507 allows the robot to travel on the Preferred Route 507 in a specified direction. The system invites the user to click a bidirectional option if the user desires to select a bidirectional directionality for the Preferred Route 507. The bidirectional option allows the robot to travel on the Preferred Route 507 in either direction. Alternatively, or additionally, the system determines the directionality of the Preferred Route 507 using one or more of a system default, a system algorithm, and a user instruction.

The system invites the user to right click on the Preferred Route 507 to open the Robot Permissions menu 530. The user can click on an option to do one or more of extend the Preferred Route 507 with a one-way route, extend the Preferred Route 507 with a two-way route, merge the Preferred Route 507 with a second route, and delete the Preferred Route 507. A user can click hold the control (+ctrl) key on the computer keyboard and click on multiple Preferred Routes 507 to multi-select and edit multiple routes at once.

FIG. 6 is a wireframe of a Route Filter Tool 600 for the robot management system. As discussed above with reference to FIG. 3, upon user selection of the Route Filter tab (not shown in this figure), the system provides a Route Filter Tool overlay 605 to the map of the facility showing a route that is prohibited for one or more of the selected robot and the selected cart.

If the user restricts a robot from using a Preferred Route, the Route Filter Tool overlay 605 allows the user to select the type of robot that is restricted. If a user restricts a cart from using a Preferred Route, the Route Filter tab allows the user to select the type of cart that is restricted. For example, the system highlights Preferred Routes from which one or more of a robot and a cart is restricted.

A user can click on the Route Filter tab to see a Route Filter popup 605. A user can select a robot to see if the robot is prohibited from traveling on a Preferred Route as defined in Preferred Route as discussed in FIG. 5. Alternatively, or additionally, the user can select a cart to see if the cart is prohibited from traveling on a Preferred Route as defined in Preferred Route as discussed in FIG. 5. For example, the user can see which routes Robot Type 1 is forbidden from traveling on by clicking the checkbox then clicking the “Apply” button 610. The system provides the Route Filter Tool overlay 605 to the map of the facility showing routes on which the selected robot or cart type will not travel.

FIG. 7 is a wireframe of a Survey Route Annotation Tool page 700 for the robot management system. A data survey robot is defined as a robot configured to collect data. For example, the data survey robot comprises an RFID reader. For example, the data survey robot is configured to collect data using an RFID tower. A Survey Route is a route used by a data survey robot. If the user selects the map Annotation Tool Survey Route tab 310 from the Edit Annotations page 300 as shown in FIG. 3, the system receives the user's selection and presents the user with the Survey Route Annotation Tool page 700. The provided Coverage overlay 328 allows the user to ensure that the data survey robot follows a route that will allow its sensor to read a tag identifying the route. For example, the sensor comprises a radio frequency identification (RFID) sensor. For example, the tag comprises an RFID tag. For example, the tag comprises an embedded RFID tag. For example, the RFID tag comprises a unique RFID tag configured to distinguish the route from other routes.

The Survey Route Annotation Tool page 700 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352.

To add a Survey Route to the map 106 of the facility 102, the user clicks on the map 106 to draw Survey Route points 705A-705D. When the user places a Survey Route point 705A-705D, the system invites the user to specify a survey orientation 707 in which the data survey robot will turn to gather data at this Survey Route point 705A-705D. The user can use a survey orientation arrow to define the survey orientation.

The system generates the Survey Route 710 that best fits the Survey Route points 705A-705D. For example, if the user sees a material on a left side of an aisle, the user can select an orientation so that the robot will face the material during the data survey. For example, the user may orient the data survey robot toward the material so the data survey robot gathers data regarding the material. For example, the material is embedded with a unique RFID tag.

The Survey Route Annotation Tool page 700 further comprises a Survey Route sidebar 712. The Survey Route sidebar 712 comprises a Data Survey name 715. For example, the user can select the Data Survey name 715 after the Data Survey route 710 is created. Alternatively, or additionally, the user can select the Data Survey route name 715 before the Data Survey route 710 is created. If the user does not select the Data Survey route name 715, the system selects as a default for the Data Survey route name 715 the words “Data Route” followed by a three-digit number.

A user can click on the Show Survey Coverage tab 328 to see a system estimate of coverage of the map 106 of the facility 102 by the sensor of the data survey robot. For example, the user can click on the Show Survey Coverage tab 328 to see the system coverage overlay 720 showing the system's estimate of coverage of the map 106 of the facility 102 by the RFID sensor of the data survey robot. For example, the user can click on the Show Survey Coverage tab 328 to see the system estimate of coverage of the map 106 of the facility 102 by the RFID sensor of the data survey robot while the data survey robot is traveling on the Survey Route 710. Upon selection of the Show Survey Coverage tab 328 by the user, the system provides a coverage overlay 720 to the map 106 of the facility 102 showing an estimated coverage region that the robot's sensors will read while traveling on the Survey Route 710.

FIG. 8 is a wireframe of a Robot Destination Annotation Tool page 800 for the robot management system. A Robot Destination is defined as a location designated by the user as a navigation goal. If the user selects the map Annotation Tool Robot Destination tab 312 from the Edit Annotations page 300 as shown in FIG. 3, the system receives the user's selection and presents the user with the Robot Destination Annotation Tool page 800.

The Robot Destination Annotation Tool page 800 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352. The Robot Destination Annotation Tool page 800 further comprises a Robot Destination 810, a Robot Destination orientation 512, and a destination orientation arrow 815.

To add a Robot Destination 810 to the map of the facility, the user clicks on a selected Robot Destination type 312. After the user selects the Robot Destination type, the system shows the cursor as a Robot Destination icon. The user then clicks on the map 106 to place the Robot Destination 810. For example, the system creates a Robot Destination 810 having a size scaled to match a size of the robot. For example, as depicted, the Robot Destination 810 comprises a circle.

When the user places the Robot Destination 810, the system invites the user to specify the destination orientation 812 of the robot at this Robot Destination 810. The user can use a destination orientation arrow 815 usable by the user to orient the Robot Destination 810 to define the destination orientation 812. For example, as depicted, the destination orientation 812 comprises a pointed triangle on a side of the circle, the pointed triangle pointing in a direction that indicates the robot orientation 812.

The Robot Destination Annotation Tool page 800 further comprises a Robot Destination sidebar 820. The Robot Destination sidebar 820 comprises a Robot Destination name 825, a destination directionality 830, a unidirectional destination option 835, a bidirectional destination option 840, a destination group menu 845, a destination group 850, a destination access setting 855, and a destination access checkbox 860. For example, the user can select the Robot Destination name 825 after the Robot Destination 810 is created. Alternatively, or additionally, the user can select the Robot Destination name 825 before the Robot Destination 810 is created.

The system invites the user to select the destination directionality 830 for one or more of entry by the robot to the Robot Destination 810 and exit by the robot from the Robot Destination 810. The system invites the user to click a unidirectional option 835 if the user desires to select a unidirectional directionality 830 for a destination 810. The unidirectional option 835 allows the robot to do one or more of enter the destination 810 moving in a specified direction and exit the destination 810 moving in a specified direction. The system invites the user to click a bidirectional option 840 if the user desires to select a bidirectional directionality 830 for a destination 810. The bidirectional option 840 allows the robot to do one or more of enter the destination 810 moving in either direction and exit the destination 810 moving in either direction.

The system invites the user to click a destination group menu 845 if the user wishes to create a destination group 850. The destination group menu receives the user's assignment of one or more destinations 810 to the destination group 850. The destination group 850 comprises destinations 810 usable by the robot. For example, the system creates a destination group 850 that comprises three alternative destinations (not shown in the figure), all of which the user specifies as an acceptable destination 810 for the robot to complete a task. As a default setting subject to change by the user, the system automatically includes the current destination 810 in the destination group 850. The system invites the user to use the destination access settings 855 to specify one or more of a type of robot and a type of cart that can access the destination 810. By default, all robots 101 are allowed to access the destination 810. To disallow a robot from using the destination 810, the user clicks the destination access checkbox 860 next to the robot type to deselect it.

The system invites the user to right click on a destination 810 to access a dropdown edit destination menu 865. Using the edit destination menu 865, the user can delete the destination 810 or add a robot queue to the destination. If a destination has a robot queue, a robot will wait in line if the destination 810 is occupied by another robot. The robot will move into the destination 810 when the destination 810 becomes available.

FIG. 9 is a wireframe of a Keepout Zone Annotation Tool page 900 for the robot management system. As mentioned above, a Keepout Zone refers to an area that is unavailable to the robot. The Keepout Zone applies to all robots on the map. Where the robots to which the Keepout Zone are selected, the selection occurs by one or more of a system default, a system algorithm, and a user designation. For example, the user may create a Keepout Zone for an area comprising one or more of stairs, shelving, and other objects to be avoided by the robot. If the user selects the map Annotation Tool Keepout Zone tab 314 from the Edit Annotations page 300 as shown in FIG. 3, the system receives the user's selection and presents the user with the Keepout Zone page 900.

The Keepout Zone page 900 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, the “Exit Edit Mode” button 348, the “More Options” button 350, and the map scale 352.

The Keepout Zone page 900 further comprises a Keepout Zone 910. To add the Keepout Zone 910 to the map 106 of the facility 102, the user selects the keepout tab 314 then selects a drawing tool. The drawing tool comprises one or more of a Polygon tool and a Rectangle tool.

The Polygon tool allows the user to create a unique shape on the map 106. The Rectangle tool allows the user to click and drag to draw a rectangle on the map. After the user selects the drawing tool, the mouse cursor becomes the drawing tool and the user can click on the map 106. The user then draws the Keepout Zone 910.

FIG. 10 is a wireframe of a Speed Limit Zone Annotation Tool page 1000 for the robot management system. As mentioned above, a Speed Limit Zone refers to an area in which the system, based on one or more of a system default, a system algorithm, and a user instruction, instructs the robot that it has one or more of a minimum speed of travel and a maximum speed of travel. For example, the user may create a Speed Limit Zone for an area that comprises one or more of a busy intersection and reduced visibility for a robot, and reduced visibility for a human. For example, the reduced visibility for the human may be attributable to one or more of driving material handling equipment that obstructs the human's vision, other objects in the vicinity, and a task the human is performing. If the user selects the map Annotation Tool Speed Limit Zone tab 316 from the Edit Annotations page 300 as shown in FIG. 3, the system receives the user's selection and presents the user with the Speed Limit Zone page 1000.

The Speed Limit Zone page 1000 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352.

The Speed Limit Zone page 1000 further comprises a Speed Limit Zone 1010. To add the Speed Limit Zone 1010 to the map 106, the user selects a drawing tool. The drawing tool comprises one or more of a Polygon tool and a Rectangle tool.

The Polygon tool allows the user to create a unique shape on the map 106. The Rectangle tool allows the user to click and drag to draw a rectangle on the map. After the user selects the drawing tool, the mouse cursor becomes the drawing tool and the user can click on the map 106. The user then draws the Speed Limit Zone 1010.

The Speed Limit Zone page 1000 further comprises a Speed Limit Zone sidebar 1015. The Speed Limit Zone sidebar 1015 comprises a speed control 1020. For example, and as depicted, the speed control 1020 comprises a speed slider 1020. Using the speed slider 1020, the user specifies one or more of a minimum speed of travel in the Speed Limit Zone 1010 and a maximum speed of travel in the Speed Limit Zone. As shown, the user has selected a minimum speed of travel of 0.3 meters per second. As shown, the user has selected a maximum speed of travel of 1.5 meters per second.

FIG. 11 is a wireframe of a Obstacle-Free Area Annotation Tool page 1100 for the robot management system. As mentioned above, an Obstacle-Free Area refers to an area not comprising an obstacle that interferes with the navigation of the robot. For example, the Obstacle-Free Area may comprise an area that was occupied when the map 106 of the facility 102 was created but that does not actually comprise a permanent obstacle. For example, the user may create an Obstacle-Free Area for an area comprising one or more of a human, a cart, a pallet, and another obstacle seen by the robot during the mapping phase but no longer an obstacle in the mapped location. If the user selects the map Annotation Tool Obstacle-Free Area Zone tab 318 from the Edit Annotations page 300 as shown in FIG. 3, the system receives the user's selection and presents the user with the Obstacle-Free Area page 1100.

The Obstacle-Free Area page 1100 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, the “Exit Edit Mode” button 348, the “More Options” button 350, and the map scale 352.

The Obstacle-Free Area page 1100 further comprises an Obstacle-Free Area 1110. To add the Obstacle-Free Area 1110 to the map 106, the user selects a drawing tool. The drawing tool comprises one or more of a Polygon tool and a Rectangle tool.

The Polygon tool allows the user to create a unique shape on the map 106. The Rectangle tool allows the user to click and drag to draw a rectangle on the map. After the user selects the drawing tool, the mouse cursor becomes the drawing tool and the user can click on the map 106. The user then draws the Obstacle-Free Area 1110.

The user can later draw over an Obstacle-Free Area 1110 when a detected obstacle is no longer present in the facility.

FIG. 12 is a wireframe of a Charging Dock Annotation Tool page 1200 for the robot management system. A Robot Destination is defined as a location designated by the user as a navigation goal. If the user selects the map Annotation Tool Charging Dock tab 220 from the Edit Annotations page 300 as shown in FIG. 3, the system receives the user's selection and presents the user with the Charging Dock Annotation Tool page 1200.

The Charging Dock Annotation Tool page 1200 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352. The Charging Dock Annotation Tool page 1200 further comprises a Charging Dock 1210, a Charging Dock orientation arrow 1212, and a Charging Dock sidebar 1215.

When the user places the Charging Dock 1210, the system presents to the user the Charging Dock sidebar 1215. The Charging Dock sidebar 1215 comprises a Charging Dock type 1220, a Charging Dock setting 1230, and a Charging Dock setting checkbox 1235.

To add a Charging Dock 1210 to the map 106 of the facility 102, the user clicks on a selected Charging Dock type 1220. After the user selects the Charging Dock type 1220, the system shows the cursor as a Charging Dock icon. The user then clicks on the map 106 to place the Charging Dock 1210. For example, the Charging Dock 1210 represents a location where a Charging Dock is physically installed in the facility 102.

The system invites the user to specify a Charging Dock orientation 1240 of the Charging Dock 1210 using the Charging Dock orientation arrow 1212.

FIG. 13 is a wireframe of a Cart Transfer Annotation Tool page 1300 for the robot management system. A Cart Transfer Location is defined as a location designated by the user where a cart transfer robot can do one or more of pick up a cart and drop off a cart. For example, the cart transfer robot picks up a cart that comprises cargo. For example, the cart transfer robot picks up the cart at a first Cart Transfer Location and drops off the cart at a second Cart Transfer Location. For example, the cart transfer robots comprise all robots 101. For example, the cart transfer robots comprise a subset of the robots 101. For example, the cart transfer robots comprise a user-designated subset of the robots 101.

If the user selects the map Annotation Tool Cart Transfer tab 322 from the Edit Annotations page 300 as shown in FIG. 3, the system receives the user's selection and presents the user with the Cart Transfer Annotation Tool page 1300.

The Cart Transfer Annotation Tool page 1300 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352. The Cart Transfer Annotation Tool page 1300 further comprises a Cart Transfer Location 1305, a cart transfer orientation 1310, a cart transfer orientation arrow 1315, a cart transfer area 1320, a cart transfer area perimeter 1325, and a cart transfer sidebar 1330. The cart transfer sidebar 1330 comprises a Cart Transfer Location name 1335.

After the user selects the Cart Transfer tab 322, the system shows the cursor as a Cart Transfer Location icon 1305. To add a Cart Transfer Location 1305 to the map 106 of the facility 102, the user clicks on a selected Cart Transfer Location 1305 on the map 106 of the facility 102.

When the user places the Cart Transfer Location 1305, the system invites the user to specify a cart transfer orientation 1310 of the cart at this Cart Transfer Location 1305. The user can use a cart transfer orientation arrow 1315 usable by the user to orient the Cart Transfer Location 1305 to define the cart transfer orientation 1310. For example, as depicted, the cart transfer orientation 1310 comprises a pointed triangle pointing in a direction that indicates the cart transfer orientation 1310.

A size of the Cart Transfer Location icon 1305 corresponds to a size of a cart transfer area 1320 needed for the cart transfer. A cart transfer area perimeter 1325 around the cart transfer area 1320 represents space the robots 101 have in order to successfully do one or more of pick up a cart and drop off a cart. The application provided, through algorithmic analysis, warnings/errors when/if the perimeter is in collision with elements on the map that would interfere with the robots ability to enter the specified perimeter.

The cart transfer sidebar 1330 comprises a Cart Transfer Location name 1335. For example, the user can select the Cart Transfer Location name 1335 after the Cart Transfer Location 1305 is created. Alternatively, or additionally, the user can select the Cart Transfer Location name 1335 before the Cart Transfer Location 1305 is created.

FIGS. 14-15 are a set of a wireframe and a storyboard showing how to configure a Precision Marker Annotation of the robot management system.

FIG. 14 is a wireframe showing configuration of a Precision Marker Annotation Tool page 1400 for the robot management system. The Precision Marker Annotation tool 1400 is used to send a robot to a specific position on the map 106 to align with any fixed infrastructure such as a conveyor system, a robot arm, etc. Precision alignment enables transport of goods between the robots and equipment. The position of the fixed infrastructure is marked with a Precision Marker on the map. Physical Precision Markers are physically installed in the facility, then added to the map as a map Precision Marker to indicate where in the facility the Physical Precision Marker is located. The map Precision Markers are used to configure one or more of a horizontal x direction offset of the map Precision Marker and the Physical Precision Marker, a horizontal y direction offset of the map Precision Marker and the Physical Precision Marker, and a theta offset indicating an angle at which the robot approaches the Physical Precision Marker. The system uses the offsets to correction locate the map Precision Marker.

If the user selects the map Annotation Tool Precision Marker tab 224 from the Edit Annotations page 300 as shown in FIG. 3, the system receives the user's selection and presents the user with the Precision Marker Annotation Tool page 1400.

The Precision Marker Annotation Tool page 1400 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352. The Precision Marker Annotation Tool page 1400 further comprises a Precision Marker icon 1405, a Precision Marker annotation 1410, a Precision Marker arrow icon 1415, and a Precision Marker sidebar 1420. The Precision Marker sidebar 1420 comprises a Precision Marker name field 1425, a first field 1430, a second field 1435, and a third field 1440.

After the user selects the Precision Marker tab 324 in FIG. 3, the user can click the Precision Marker icon 1405 in the annotations toolbar. At this time, the mouse cursor becomes a Precision Marker icon and the user can click on the map to place the Precision Marker 1410. The user can specify the orientation of the Precision Marker 1410 by selecting the Precision Marker arrow icon 1415 and dragging it to rotate the Precision Marker arrow icon 1415. Next, the user configures the Precision Marker in the Precision Marker sidebar 1420. A name can be added using the Precision Marker Name field 1425. Next, the user calibrates the alignment offset so the robots 101 know how to align themselves to the Precision Marker 1410.

The user calibrates the robot alignment to a Precision Marker 1410 in two ways: manually entering values or using the robot. Manually entering values is a simple and easy way to customize workflow in cases where a user has either measured first, or has an accurate representation of the facility (e.g., a computer-aided design [CAD] model) that the user can reference. The user fills in the first field 1430 to specify the distance between the robot and the Precision Marker 1410. The distance (in cm) between the robot and the Precision Marker 1410 can be between 5 cm (2 in) and 75 cm (29.5 in).

To specify an angle at which the robot is oriented relative to the Precision Marker 1410, the user fills in the second field 1435 and specifies the angle. To move the marker to the left, the user inputs a negative value for the second field 1435. To move the marker to the right, the user inputs a positive value for the second field 1435. The angle can be between −5 and 5 degrees.

To specify a side-to-side offset (in cm) of the robot relative to the center of the Precision Marker 1410, the user fills in the third field 1440. To indicate that the robot is to the right of the Precision Marker 1410, the user inputs a positive value for the third field 1440. To move the Precision Marker 1410 to the right, the user inputs a positive value for the third field 1440. Offset can be between −10 cm (−3.9 in) and 10 cm (3.9 in). The user clicks “Apply,” then clicks “Test Alignment.” A robot then travels to the location in the facility 102 and demonstrates that alignment. The user can continue to re-enter the offsets until the robot is properly aligned. To auto-calibrate the Precision Marker 1410 using a robot, the user publishes the map 106 then re-enters Edit Mode. Since the robots 101 can only use map annotations that have been published, this step is necessary for auto-calibration.

The Precision Marker sidebar 1420 comprises a robot list 1450, an “Apply” button 1460, a “Calibrated” legend 1470, an Offsets field 1480, and a “Test Alignment” button 1490.

FIGS. 15A-15D is a series 1500 of four drawings of a user configuring a Precision Marker using an automatic calibration method of the robot management system.

In FIG. 15A, a robot 101 comprising a roller-top conveyor 1510 approaches a conveyor belt 1520 for one or more of a pickup and a dropoff. A similar method applies if instead of a roller-top conveyor 1510, the location for the one or more of a pickup and a dropoff comprises one or more of a wall and a staging area.

In FIG. 15B, rather than manually entering the offsets from the Precision Marker as in FIG. 14, the user annotates the map by placing a physical Precision Marker 1410 under the conveyor belt 1520. Shown again are the robot 101, the roller-top conveyor 1510 and the conveyor belt 1520.

In FIG. 15C, the user prompts the system to publish the map so that the user annotation of the physical Precision Marker 1410 is visible to the robot 101 on the map 106 as a Precision Marker map annotation 1530. Using the Precision Marker map annotation 1530 comprised in the map 106, the robot 101 automatically calibrates alignment with the physical Precision Marker 1410 at a Precision Marker destination 1540. The user then returns the system to the Edit Mode page 300 as shown in FIG. 3. The robot 101 uses its sensors to determine offsets so as to position itself in front of the conveyor belt 1520 at a current alignment of the Precision Marker destination 1540 and the physical Precision Marker 1410. Shown again are the roller-top conveyor 1510 and the conveyor belt 1520.

In FIG. 15D, to do the alignment, the user drives the robot 101 in Joystick Mode and positions the robot 101 in front of the conveyor belt 1520. Once the robot 101 is positioned correctly, the user uses the robot management system to automatically calibrate alignment of the physical Precision Marker 1410 and the Precision Marker destination 1540. Using a tablet 1550, the user places a Precision Marker indicator 1560 on the map 106 where the conveyor belt 1520 aligns with the Precision Marker 1410. The user then publishes the map 106.

The user gives a unique name to the Precision Marker 1410 using the Precision Marker name field 1425 shown in FIG. 14. Next the user selects the robot 101 from the robot list, and clicks on the “Scan Marker” button. The values of the current alignment will now populate in the Precision Marker sidebar 1420 shown in FIG. 14. If necessary, the user can adjust the alignment of the robot 101, and click the “Scan Marker” button again. The user repeats this step until all values are valid, then clicks the “Apply” button 1460 shown in FIG. 14. Once the system has calibrated offsets, the system displays the “Calibrated” legend 1470 shown in FIG. 14. The system populates the Offsets field 1480 shown in FIG. 14 with values. To test the alignment in real-time, the user can click the “Test Alignment” button 1490 shown in FIG. 14 and the robot 101 will reposition itself according to the offsets in the Offsets field 1480 shown in FIG. 14.

FIG. 16 is a wireframe of a Text Label Tool page 1600 for the robot management system.

If the user selects the map Annotation Tool Text Label tab 326 from the Edit Mode page 300 as shown in FIG. 3, the system receives the user's selection and presents the user with the Text Label Tool page 1600.

The Text Label Annotation Tool page 1600 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the robot ID 147, the map name 148, the Zoom In button 170, the Zoom Out button 175, the Fit to Page button 180, the Preferred Route tab 308, the Survey Route tab 310, the Robot Destination tab 312, the Keepout Zone tab 314, the Speed Limit Zone tab 316, the Obstacle-Free Area tab 318, the Charging Dock tab 320, the Cart Transfer tab 322, the Precision Marker tab 324, the Text Label tab 326, the Show Survey Coverage tab 328, the WiFi Map tab 330, the Route Filter tab 332, the Show Grid tab 334, the Rotate Map button 336, and the map scale 352. The Text Label Tool page 1600 further comprises a Text Label sidebar 1610 comprising a Text Label box 1615, and a Text Label 1620. The Text Label 1620 can be used to specify a certain area such as a “Cart Docking Area.” Alternatively, or additionally, the Text Label 1620 can be used to provide general information such as an aisle number to assist the user in interpreting the map 106.

After the user selects the Text Label tab 326, the system shows the Text Label box 1615. To add a Text Label 1620 to the map 106 of the facility 102, the user clicks on a selected Text Label location 1620 on the map 106 of the facility 102. The user then types the desired Text Label 1620. As shown, the user selected the Text Label 1620 reading, “Robot Operation Area.”

FIG. 17 is a WiFi wireframe 1700 of the WiFi Map tab 330 of the robot management system. Upon user selection of the WiFi Map tab 330, the system provides a WiFi overlay 1705 to the map 106 of the facility 102 showing an estimated connectivity strength of a WiFi network. Additionally, or alternatively, the WiFi Map tab 330 upon selection by the user provides a WiFi overlay 1705 to the map 106 of the facility 102 showing a WiFi access point.

The WiFi wireframe 1700 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the Zoom In button 170, the Zoom Out button 175, the Fit to Page button 180, the Text Label tab 326, the Show Survey Coverage tab 328, the WiFi Map tab 330, the Route Filter tab 332, the Show Grid tab 334, the Rotate Map button 336, the “Exit Edit Mode” button 348, and the “More Options” button 350.

During the map building process, the robots 101 collect data on the WiFi signal strength throughout the facility. For example, the WiFi Map is presented as a colored overlay 1705 on the map 106 of the facility 102 showing WiFi coverage. For example, the WiFi Map 1705 is presented as a colored overlay 1705 on the map 106 of the facility 102 that visualizes the signal data. As a robot traverses a map, it sends to the server (besides the signal strength) signal origination data. For example, the signal origination data comprises one or more of a Network Service Set Identifier (SSID) and an access point Identifier. This WiFi map 1705 visualizes the signal data using color on a gradient from red to green as outlined in a Connectivity Strength map legend 1710. For example, red means the WiFi signal is weak, yellow means the WiFi signal is average, and green means the WiFi signal is strong.

FIG. 18 is a wireframe of a Maps page 1800 in the robot management system. As discussed above with reference to FIG. 3, upon user selection of the Show Grid tab 334, the system provides a Grid tool overlay 1803 to add orthogonal gridlines 1805 to the map. The orthogonal gridlines 1805 can assist the user in drawing straight lines during map annotation, for example, a straight Preferred Route. The user can click on a dropdown arrow 1810 next to the map name 346 to open a map list 1815 comprising all maps in the robot management system. A user can open a different map by clicking on a map name in the list 1815.

The Maps page 1800 again comprises the map 106, the facility 102, the Analytics tab 109, the Maps tab 110, the Robots tab 115, the Devices tab 120, the Users tab 125, the Tasks tab 130, the Settings tab 135, the Reports tab 140, the Admin tab 145, the Zoom In button 170, the Zoom Out button 175, the Fit to Page button 180, the Text Label tab 326, the Show Survey Coverage tab 328, the WiFi Map tab 330, the Route Filter tab 332, the Show Grid tab 334, the Rotate Map button 336, the “Exit Edit Mode” button 348, the “More Options” button 350.

FIG. 19 is a wireframe of a Robots page 1900 for the robot management system. If the user selects the robots tab 115 on the home page 100 as shown in FIG. 1, the system sends the user to the Robots page 1900. The Robots page 1900 comprises a robots list 1910. The robots list 1910 comprises a robot identification (ID) 1915, a robot status 1920, a battery charge level 1925 and a connectivity strength 1930. The Robots page 1900 further comprises a robot status 1935, an energy level 1940, a Connectivity Strength 1945, a joystick mode toggle 1950, a task type 1960, a unique task ID 1965, a robot settings pane 1970 comprising information about robot configurations 1975, a robot footprint 1980, a robotic map update 1985, a robotic map icon 1990, and a robotic options menu 1995.

The Robots page 1900 again comprises the map 106, the facility 102, the Analytics tab 109, the Maps tab 110, the Robots tab 115, the Devices tab 120, the Users tab 125, the Tasks tab 130, the Settings tab 135, the Reports tab 140, and the Admin tab 145.

Once a customer purchases a fleet of the robots 101, the system adds a purchased robot to the robot management system. Preferably, once the customer purchases the fleet of the robots 101, the system adds each purchased robot to the robot management system. Each robot in the fleet is seen in the robots list 1910, listed by Robot ID 1915. The user selects a robot to see detailed information about that robot ID 1915 in the main page. In addition to the Robot ID 1915, the robots list 1910 contains a preview of robot information: robot status 1920, battery charge level 1925, and connectivity strength 1930. The user can click on any robot to see more information. Each robot page contains the following information: Robot Status 1935 shows the current status of the robot. Possible statuses include Offline, Idle, Working, Charging, Error, Mislocalized, Stopped, Joystick, and Low-Battery. The energy level 1940 comprises, as shown, a battery level 1940. The Power Level 1940 shows a current power level of the robot. For example, the Power Level 1940 shows a current battery level of the robot. Hovering over the icon shows the battery percentage. The Connectivity Strength 1945 comprises, as shown, a Connectivity Strength 1945 showing a strength of a WiFi connection of the robot.

The Robots page 1900 includes a Joystick Mode toggle 1950 that the user clicks to alternately start and stop autonomous operation. Each cordless controller comes with a dongle. To enable the Joystick Mode, the user inserts the dongle into a USB port on the access panel of the physical robot. The user then presses and holds a button to start driving the robot. In the robots menu, the Joystick Mode toggle will be enabled. Once the user finishes driving the robot, they go to this page and click the toggle off to turn Joystick Mode off and resume autonomous operation.

Current Task: The Robots Tab also contains information about the tasks the robots 101 are currently working on. Each Task has a Task Type 1960 and Unique Task ID 1965. This information is listed here to inform the user what the robot is currently working on. If the robot is not working on a task, the task type and task ID says “none.”

The robot settings pane 1970 comprises information about one or more of the robot configurations 1975 and the robot footprint 1980. For example, the robot configuration 1975 comprises one or more of a type of robot base and a type of robot attachment. For example, the robot footprint 1980 comprises one or more of a size of the robot, a footprint of the robot, a size of a robotic attachment, and a footprint of a robotic attachment.

Lastly, the Robots page 1900 contains a robotic map update 1985 that allows the user to assign the robots 101 to a map. In order for the robots 101 to autonomously navigate and use map annotations to perform tasks, the user needs to add them to a map. To add a robot to a map, or move a robot to a different map, the user clicks the drop-down menu to put the robot on one of the maps in the list. Then the user localizes the robot to update where the robot is physically located in the facility with its virtual location on the map. To go to the map that the robot is assigned to, the user clicks the robotic map icon 1990 next to the map setting.

The robotic options menu 1995 comprises three vertical dots. When the user opens the robotic options menu 1995, a displayed options menu comprises two options: “Update Software Version,” which forces a software version update and “Clear Error Status,” which clears an error status of a robot. Errors include when a robot cannot connect to a cart to perform a cart transport.

FIG. 20 is a wireframe of a Devices page 2000 for the robot management system. If the user selects the Devices tab 120 on the home page 100 as shown in FIG. 1, the system sends the user to the Devices page 2000. The Devices page 2000 comprises a device list 2010, a device password field 2015, a device description field 2020, a device type menu 2025, an equipment field 2030, an equipment name field 2035, an equipment actions list 2040, a robot map menu 2045, and a device location button 2050.

The Devices page 2000 again comprises the map 106, the facility 102, the Analytics tab 109, the Maps tab 110, the Robots tab 115, the Devices tab 120, the Users tab 125, the Tasks tab 130, the Settings tab 135, the Reports tab 140, and the Admin tab 145.

For some robotic workflows, the robots need to communicate with external, internet-connected devices to control equipment in the facility. The system provides an Internet of Things (loT) device for this purpose. During initial setup, devices and the robots 101 are added to the system. Each device associated with a customer site shows on the Devices tab 2005 of the robot management system in the device list 2010. When a device is selected for the first time, the user configures the device.

The system provides an Internet-connected IoT device that can be configured on the Devices tab 200. The IoT device is configured to interface with external equipment. For example, the IoT device is configured to interface with external customer equipment. For example, the external customer equipment comprises one or more of a conveyor belt, a shelf, a wall, an arm of a stationary robot, a door, an elevator. For example, the door comprises an automatic door.

Each device has a unique password that the user enters in the device password field 2015 to configure the device. The user can add a short description of the device in the device description field 2020. For example, there may be a device controlling an elevator and another device controlling a conveyor belt. The user can add “Elevator” and “Conveyor Belt” in the respective device description fields of the devices so the user can easily differentiate them. Next, the user selects what type of device they are configuring through a device type menu 2025. For example, the device type menu comprises a dropdown device type menu 2025. The device type menu 2025 contains two options: Default devices and custom devices. Next, the user adds a type of equipment the device is controlling in the equipment field 2030. Options include “Conveyor” and “Custom.” Next the user adds a name of the equipment the device is controlling in the equipment name field 2035. The user is able to give a preferred name to the device in a textbox, such as “Repairs Conveyor.” The user can then define the number of digital/analog inputs & outputs by typing a number next to each of “digital input” “digital output” “analog input” and “analog output.”

Next the user adds actions that the equipment can perform in the equipment actions list 2040. Next the user states the robot map 106 containing the equipment using the robot map menu 2045. For example, the robot map menu 2045 comprises a robot map dropdown menu. Finally, the user clicks the device location button 2050 to specify where on the map 106 that device is located.

FIG. 21 is a wireframe of a Users page 2100 for the robot management system. If the user selects the users tab 125 on the home page 100 as shown in FIG. 1, the system sends the user to the Users page 2100. The Users page 2100 allows the user to create a user account for use of the robot management system. The Users page 2100 comprises a users list 2110, an “Add New” button 2115, a new user first name button 2120, a new user last name button 2125, a new user electronic mail (email) button 2130, a new user password 2135, and a new user role 2140, a new user save button 2145, and a new user cancel button 2150.

The Users page 2100 again comprises the map 106, the facility 102, the Analytics tab 109, the Maps tab 110, the Robots tab 115, the Devices tab 120, the Users tab 125, the Tasks tab 130, the Settings tab 135, the Reports tab 140, and the Admin tab 145.

All existing users are listed in the user list 2110. To create a new user account, the user clicks on the “Add New” button 2115 and fills in the required information: the new user first name 2120, the new user last name 2125, the new user email address 2130, the new user password 2135, and the new user role 2140. There are three types of new user roles 2140: Admin, Associate, and Tablet. The admin role can access all system functionality. The associate role can login to the system in a view-only mode to resolve errors with the robots 101. The tablet role can only log into the Cart Transfer and robot-specific applications to send the robots 101 to one or more of a pick-up destination and a drop-off destination. Once all fields are filled out, the user click the new user “save” button 2145, after which the system adds the new user to the users list 2110. Alternatively, or additionally, the user clicks the new user “cancel” button 2150 to cancel creation of the new user. To delete an existing user account, the user clicks the robotic options menu 1995 and select “delete user.” The system shows the user a warning popup message is seen before deleting the user.

FIG. 22 is a wireframe of a Task Template page 2200 for the robot management system. If the user selects the tasks tab 130 on the home page 100 as shown in FIG. 1 and then selects the task templates sub-menu 2205 on the tasks page 2200, the system takes the user to the Task Template page 2200. The tasks page 2200 comprises tasks menu 2210. The tasks menu 2210 comprises three sub-menus: Activity 2212, Task Templates 2205 and Schedules 2216. The Tasks Templates sub-menu 2205 allows the user to establish regulations and then to create workflows for efficient operation of the robot management system. Workflows comprise tasks and actions.

The Task Template page 2200 again comprises the Analytics tab 109, the Maps tab 110, the Robots tab 115, the Devices tab 120, the Users tab 125, the Tasks tab 130, the Settings tab 135, the Reports tab 140, the Admin tab 145, the “Add New” button 2115, the Task Templates sub-menu 2205, the tasks menu 2210, and the Activity sub-menu 2212.

The Task Template page 2200 further comprises a task template creation button 2215, a robot assignment menu 2230, a save new task template button 2235, a cancel new task template button 2240, an action selection menu 2245, an add action button 2250, and a configurations field 2260.

Once a fleet of the robots 101 is localized on the appropriate map 106, the robots 101 can safely follow established regulations such as one or more forbidden areas, traffic rules, and other regulations. The next step is to create workflows for efficient operation. Workflows are created through Tasks. A Task represents an activity of a robot, and is a sequence of one or more Actions, which represent individual steps in the activity. Tasks and Actions tell the robot what to do.

The first step in creating robot workflows is creating a Task Template. To create a Task Template, the user clicks the task template creation button 2215. Next, the user assigns a robot using the robot assignment menu 2230. For example, the robot assignment menu 2230 comprises a drop-down menu. Then, the user adds actions. The basic unit of work in the robot management system is an action. Each task is composed of a sequence of actions performed by the robot. For example, when carrying out a task, several actions within the task might tell the robot to go to a particular destination (action 1), show buttons on the HMI display (action 2) and wait for a button to be pressed (action 3) then go to another destination (action 4). After stacking actions in a task template, the user clicks the save task template button 2235 and the new task template is added to the left pane. Alternatively, or additionally, the user clicks the cancel new task template button 2240 to cancel creation of the new task template.

To select the first action in a task template, the user selects an action in the action selection menu 2245. For example, the action selection menu 2245 comprises a dropdown action selection menu. To add an additional action not currently included in the action selection menu 2245, the user clicks the “add action” button 2250. Alternatively, or additionally, to add an additional action not currently included in the action selection menu 2245, the user clicks an “add action” button 2250 to add an action. As depicted, the “add action” button 2250 comprise two clickable plus signs adjacent to a “Select Action” legend. As the user builds the Task Template, the system populates the required configurations field 2260 with necessary robot configurations required to successfully complete the task.

Following are examples of representative actions selectable by the user using the “add action” button 2250:

Go to Destination Action: Send the robots to a specific destination in the facility. The user selects this action, select a map, then selects a destination that is annotated on the map. When the robots execute this action, they autonomously navigate to the specified destination.

Wait for Destination Selection Action: This action requires human interaction through a Human Machine Interface (HMI). For this action, the robots 101 wait at a Robot Destination and show buttons on the HMI that correspond to Robot Destinations on the map. The user selects this action, then defines a button name that will show up on the HMI. Then, the user selects the next action. The user then selects a Robot Destination to which the robot will go when the button name is pressed. When the robot executes this action, it waits in place for a person to select a destination on the HMI. After a human presses a destination button on the HMI, the robot will autonomously navigate to the selected destination.

Wait for Button Press Action: This action requires human interaction through the HMI. Upon execution of this action, robots will stay at the current location until the button is pressed (e.g. if cargo is to be be unloaded before the robot starts a new action, the robot waits for a human interaction before beginning a new action). The user selects this action, then defines a button name that will show up on the HMI. The user can define what happens next by adding another action to the task template.

Play Sound Action: Upon execution of this action, the robot will play a sound for a predefined amount of time. This action is used to do one or more of alert a human about a required interaction with the robot and to increase safety by making sure the robot is heard. Sound options include: Low Pitch Beep, Low Pitch Beeps Melody, Medium Pitch Beeps (×2), High Pitch Beep, High Pitch Beeps Melody, Chirp, Foghorn. The user selects the number of times the robot plays the sound and the volume of the sound.

Wait at Destination Action: Upon execution of this action, the robot will wait in place for a predefined waiting period. The user selects this action, then defines the waiting period.

Charge Action: The user selects this action, selects a map, then selects a Charging Dock that is annotated on the map. The user can leave the Charging Dock set to ‘Auto Selected Dock’ and the robot will go charge at an available Charging Dock. The user then defines one or more of a charge period of time and a charge level to be reached.

Survey Action: This action enables the user to set up a survey robot to autonomously scan an RFID tag in a facility. The user selects the action, selects a map in the time field, then selects a Data Survey route in the time field that is annotated on the map. Upon execution of this action, the survey robot autonomously navigates to the first position on the Data Survey route, turns on the RFID readers, and travels along the route collecting data.

Connect to Cart Action: Upon execution of this action, the robot autonomously navigates to a Cart Transfer Location, goes under a cart, and connects to the cart. The user selects this action, selects a map in the time field, then selects a Cart Transfer Location that is annotated on the map.

Disconnect from Cart Action: Upon execution of this action, a robot that has picked up a cart autonomously navigates to a Cart Transfer Location, and lowers pins to disconnect from the cart and drop it off. The user selects this action, select a map, then select a Cart Transfer Location that is annotated on the map.

Precision Alignment Action: Precision Alignment actions are used to ensure that a robot positions itself within a predetermined accuracy of a conveyor. For example, the predetermined accuracy comprises 5 millimeters (mm). A physical marker is placed in the facility that the robot recognizes and to which it autonomously navigates. A Precision Marker is placed on the map in the same location as the physical marker and aligned to the physical marker in the facility. Through the Precision Marker tool on the map, the user specifies an angle at which the robot approaches the conveyor, the distance between the marker and the robot, and a side-to-side alignment of the robot to the center of the physical marker. The user selects this action, select a map, then select a Precision Marker that is annotated on the map. Upon execution of this action, the robot autonomously navigates to the Precision Marker and aligns with it. The robot can then interact with the equipment using a Trigger Device action.

Trigger Device Action: This action allows the user to configure tasks where the robot interacts with a device the user has configured. The user can select a device and can then select an action that the device is configured to perform.

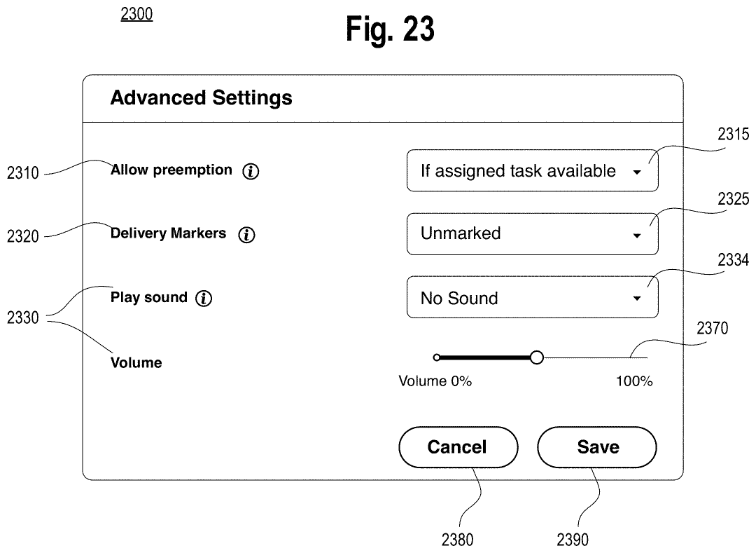

FIG. 23 is a zoomed-in wireframe of a settings popup 2300 for the robot management system. The settings popup 2300 comprises action settings to which the system takes the user after the user selects the three-dot options menu on an action 2245 in FIG. 22.

The settings popup 2300 comprises a preemption button 2310, a preemption menu 2315, a delivery markers button 2320, a delivery markers menu 2325, a play sound button 2330, a play sound menu 2335, a volume control 2370, a cancel settings button 2380, and an apply settings button 2390. For example, and as depicted, the preemption menu 2315 comprises a preemption dropdown menu. For example, and as depicted, the delivery markers menu 2325 comprises a delivery markers dropdown menu. For example, and as depicted, the play sound menu 2335 comprises a play sound dropdown menu.

Using the preemption button 2310, the user determines if an action can be interrupted by another task. The system keeps track of preemption settings, prioritizes tasks, and determines when preemptions occur for each robot. The preemption menu 2315 comprises at least three options regarding allowing preemption: Never, If assigned task available (default if nothing is selected), If any task available. Actions set to “Never” cannot be preempted by any new task. For example, a Go To Destination action can be set to Never to prevent the robots 101 from picking up a new task when they are carrying cargo to a destination. Actions set to “If assigned task available” can only be preempted if one or more of the system and the user requests a specific robot. Otherwise, preemption is ignored. Actions set to “If any task available” can be preempted by any new task.

Using the delivery markers button 2320, the user determines which actions signal one or more of a start and an end of a delivery for purposes of measuring one or more of robot delivery performance and system delivery performance. The delivery marker menu 2325 comprises at least three options regarding delivery markers: Unmarked (default if nothing is selected), Start of Delivery, and End of Delivery. The second option treats a start of delivery as comprising a connection of a robot to a cart. The third option treats an end of delivery as comprising a disconnection of a robot from a cart.

Using the play sound button 2330, the user determines what sound the robot plays while executing an action. The sound menu 2335 comprises at least two options regarding sound: No Sound (default if nothing is selected), Play Sound.

The user selects a volume for the sound using the volume control 2370. For example, the volume control 2370 comprises a slider. When the user selects a sound, a “Preview Sound” link appears so they can play the selected sound through the browser. To exit the settings page 2300 without applying changes, the user clicks the cancel settings button 2380. To apply changes to the settings page 2300, the user clicks the apply setting button 2390.

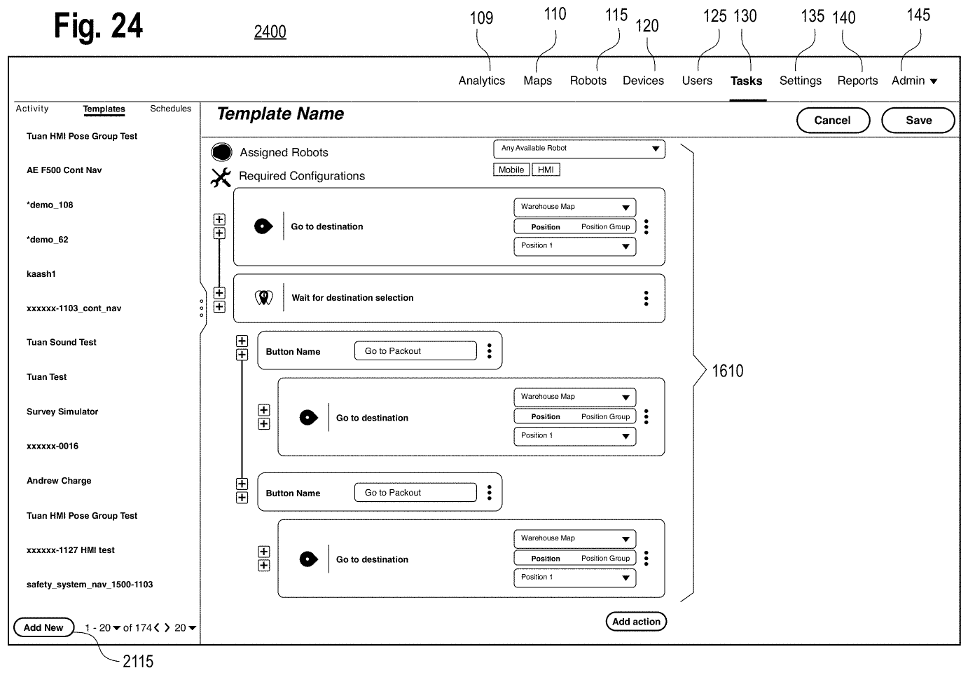

FIG. 24 is a wireframe of a completed task template 2400 for the robot management system. The completed task template 2400 comprises at least one action block 2410 for tasks that have been completed. As depicted, the completed task template 2400 comprises a plurality of action blocks 2410 for tasks that have been completed. A user can select these action blocks 2410 one by one. As depicted, the completed task template 2400 will result in the following actions: the robot will go to a destination, show buttons on the HMI display, then go to the selected destination.

The completed task template 2400 again comprises the Analytics tab 109, the Maps tab 110, the Robots tab 115, the Devices tab 120, the Users tab 125, the Tasks tab 130, the Settings tab 135, the Reports tab 140, the Admin tab 145, and the “Add New” button 2115.

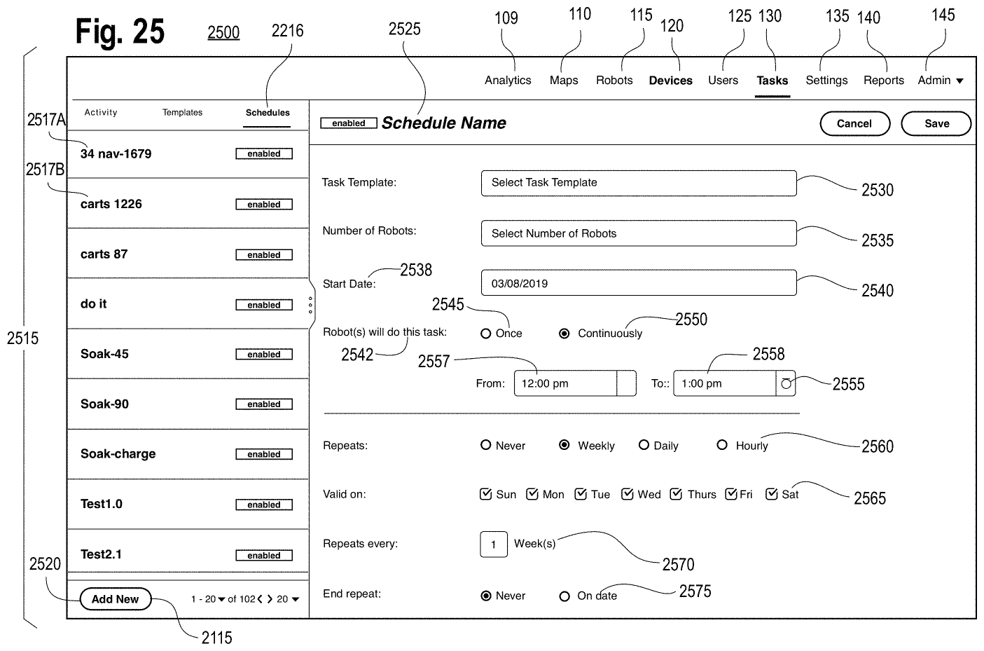

FIG. 25 is a wireframe of a Task Schedule page 2500 for the robot management system. If the user selects the Schedules sub-menu 2216 on the Task Template page 2200 as shown in FIG. 22, the system takes the user to the Task Schedule page 2500.

The Task Schedule page 2500 again comprises the Analytics tab 109, the Maps tab 110, the Robots tab 115, the Devices tab 120, the Users tab 125, the Tasks tab 130, the Settings tab 135, the Reports tab 140, the Admin tab 145, the Task Templates sub-menu 1605, the tasks menu 1610, and the Activity sub-menu 1612. The Task Schedule page 2500 further comprises a task sidebar 2515, an “add new task” button 2520, a schedule name field 2525, a task template menu 2530, a robot menu 2535, a start date field 2538, a start date calendar widget 2540, a task frequency legend 2542, a “once” button 2545, a “continuously” button 2550, a time range menu 2555, a start time 2557, an ending time 2558, a repetition frequency menu 2560, a valid days field 2565, a repetition field 2570, an end repetition menu 2575, a save schedule button 2580, and a cancel schedule button 2585.

Sequences of actions are defined in a Task Template. To define when the robots 101 will do those tasks, the user configures Task Schedules on the Tasks page 130 and in the Schedules sub-menu 2216. The task sidebar 2515 comprises a list of existing scheduled tasks 2517A, 2517B, and so on. The user can schedule a task at a specific time. Alternatively, or additionally, a task can be performed at some time during a period of time that the user defines for that task by creating a schedule for the task.

To create a schedule for a task, the user clicks the “add new schedule” button 2520. The user gives the scheduled task a name by filling the schedule name field 2525.

The user selects a task template to schedule using the task template menu 2530. For example, the task template menu 2530 comprises a dropdown menu. The user then selects a number of the robots 101 to work on the task template using the robot menu 2535. For example, the robot menu 2535 comprises a dropdown menu.

The user selects a start date by typing a date using the start date field 2538. Alternatively, or additionally, the user selects the start date by using the start date calendar widget 2540. The start date calendar widget 2540 automatically highlights a current date.

The user selects a task frequency legend 2542. If the user selects the “once” button 2545, the system will instruct the robots 101 to do the task once at the specified time. If the user selects the “continuously” button 2550, the robots 101 will do the task repeatedly during the specified block of time. The user selects a range of time using the time range menu 2555. For example, and as depicted, the time range menu 2555 comprises a drop down menu. For example, and as depicted, the time range menu 2555 comprises the start time 2557 and the ending time 2558.

The user uses the repetition frequency menu 2560 to selection a repetition frequency. As depicted, the user chooses on the repetition frequency menu 2560 one of Never, Weekly, Daily and Hourly.

The user uses the valid days field 2565 to define days of the week when the schedule can run. As depicted, the user chooses in the valid days field 2565 one or more days of the week.

The user uses the repetition field 2570 to decide a repetition period for the schedule. As depicted, the user chooses in the repetition field 2570 a number of one of hours, days, and weeks.

The user uses the end repetition field 2575 to decide how to end the repetition of the schedule. As depicted, the user chooses in the end repetition field 2575 from either “never” or ending on a date the user selects.

Once the user completes the schedule, the user clicks on the save schedule button 2580 to save the schedule. Alternatively, or additionally, the user clicks on the cancel schedule button 2585 to cancel the schedule.

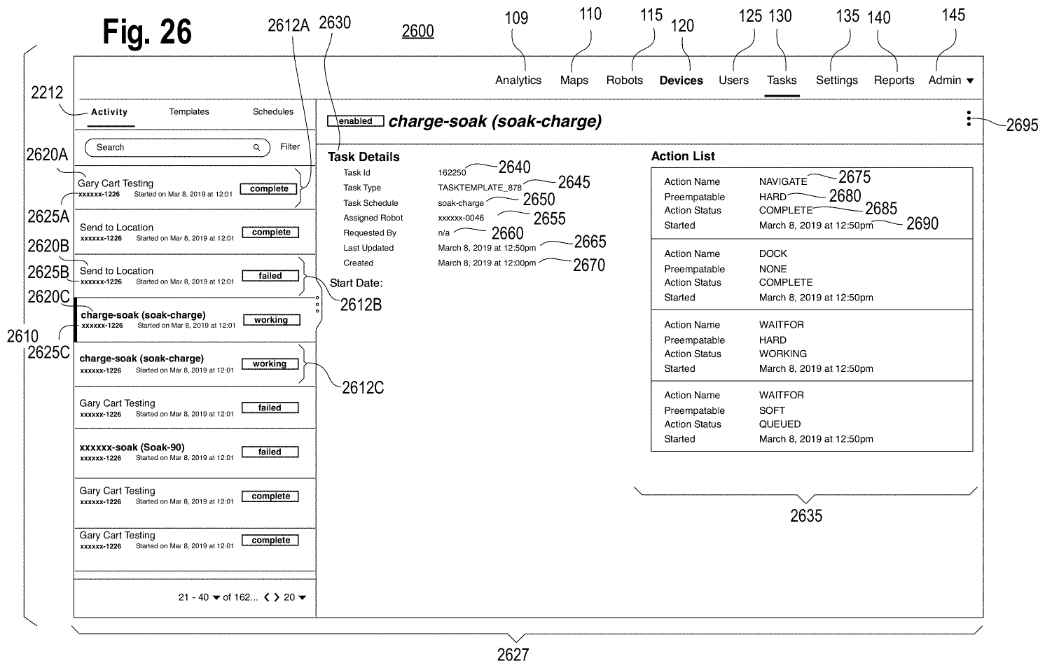

FIG. 26 is a wireframe of a Task Activity page 2600 for the robot management system. If the user selects the Activity sub-menu 2212 on the Task Template page 2200 as shown in FIG. 22, the system takes the user to the Task Activity page 2600.

The Task Activity page 2600 again comprises the Analytics tab 109, the Maps tab 110, the Robots tab 115, the Devices tab 120, the Users tab 125, the Tasks tab 130, the Settings tab 135, the Reports tab 140, the Admin tab 145, the Task Templates sub-menu 2205, the tasks menu 2210, and the Activity sub-menu 2212.

The Task Activity page 2600 further comprises an activity subtab 2605 and an activity sidebar 2610. The activity sidebar 2610 comprises tasks 2612A, 2612B, 2612C, and so on, each having respective task statuses 2615A, 2615B, and 2615C, each having respective task names 2620A, 2620B, and 2620C, and each having respective task robot designations 2625A, 2625B, and 2625C. The task 2612A comprises the task name 2620A, “Gary Cart Testing.” The task 2612B comprises the task name 2620B, “Send to Location.” The task 2612C has the “working” task status 2615C, comprises the task name 2620C, “charge-soak,” also known as “soak-charge.” The task 2612C comprises task robot designation 2625C, freight-100-0046.

The Task Activity page 2600 further comprises a main page 2627. The main page 2627 comprises Task Details 2630, an Action List 2635, a Task ID 2640, a Task Type 2645 a Task Schedule 2650, an Assigned Robot 2655, a “Requested By” field 2660, a “Last Updated” field 2665, a creation date field 2670, an Action Name 2675, a preemption level 2680, an action status 2685, an action start timestamp 2690, and an options menu 2695.

When the user creates a new robot task 2612A-2612C, the new task 2612A-2612C appears in the activity subtab 2605. Tasks 2612A-2612C are listed in the activity sidebar 2610 along with the task status 2615A-2615C, the task name 2620, and the task robot designation 2625 designating one or more of the task robot that is working on the task and the date and time when the task robot started its work on the task. Tasks can have one or more of the following task statuses. As shown, the task 2612A has a “complete” status 2615A, the task 2612B has the “failed” status 2615B, and the task 2612C has the “working” status 2615C. Preferably, but not necessarily, a task 2612A-2612C can have one of the following statuses at a given time:

New: new task that has not been assigned to a robot.

Queued: new task that has been assigned to a robot and is queued until the robot is ready to start working on it.

Working: task that robot is actively working on.

Preempted: task that a robot was working on but then interrupted to work on a different task.

Canceled: task that was cancelled by a user.

Paused: task that was paused by a user.

Failed: task that failed due to problems with the robot or the facility.

Complete: task that the robot successfully completed.

Clicking on the task 2612C in the sidebar opens up details about that task 2612C in the main page. Each task 2612A-2612C comprises Task Details 2630 and an Action List 2635. The Task Details 2630 comprises important information about that task 2612C. Task ID 2640 is a uniquely numbered identifier for that specific task. As shown, the Task ID for task 2612C comprises “162250.” The Task Type 2645 lists the name of the Task Template. Task Schedule 2650 shows the name of the schedule. Assigned Robot 2655 shows the robot ID that is assigned to the task. If the task was created by a user manually, the “Requested By” field 2660 shows the user account that requested it. Manually created tasks include “on-the-go” tasks like Send to Location, Relocalize, and the like. The “Last Updated” field 2665 shows the date and timestamp of the last time the task status was updated.

The creation date field 2670 shows a date and timestamp of when the task 2612C was created. The user can click on the links Task Type, Task Schedule, Assigned Robot, and Related Logs for details of each. The Action List shows a list of all robot actions along with the Action Name 2675, the preemption level 2680, the action status 2685, and the action start timestamp 2690. The user can click the options menu 2695 to view options including an option to pause the task 2612C and an option to cancel the task 2612C. For example, the options menu 2695 comprises a dropdown menu. For example, the options menu 2695 comprises three vertical dots.

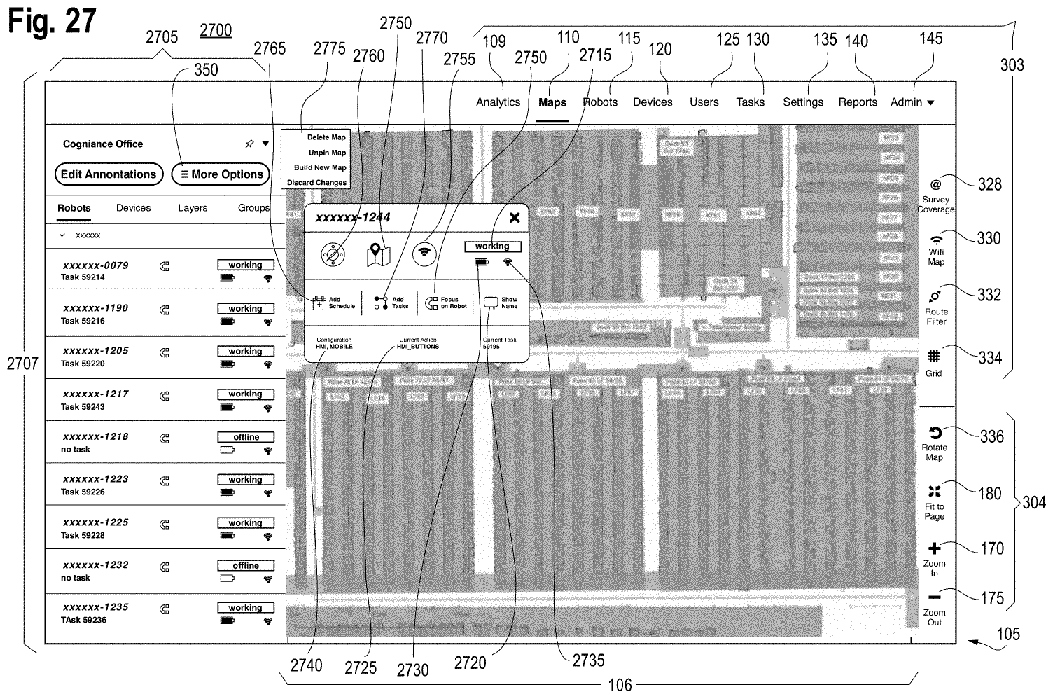

FIG. 27 is a wireframe of a Maps page 2700 for the robot management system. If the user selects the Maps tab 110 on the home page 100 as shown in FIG. 1, the system takes the user to the Maps page 2700.

The Maps page 2700 again comprises the robots 101, the Analytics tab 109, the Maps tab 110, the Robots tab 115, the Devices tab 120, the Users tab 125, the Tasks tab 130, the Settings tab 135, the Reports tab 140, the Admin tab 145, the “Exit Edit Mode” button 348, and the “More Options” button 350. The Maps page 2700 further comprises a maps sidebar 2705. The maps sidebar 2705 comprises a robot list 2707. The Maps page 2700 further comprises a maps popup 2710. The maps popup 2710 comprises tools and information for the robot. The tools and information comprise one or more of a task status 2715, a task ID 2720, a current action 2725, a power level 2730, a network level 2735, a configuration 2740, a magnet icon 2745, a “Send to Location” tool 2750, a sensor data icon 2755, a “Reset Location” button 2760, a robot schedule 2765, and a robot task 2770.

When the robots 101 are actively working on Tasks, the user can see them moving around on the map. The robot list 2707 listing the robots 101 can be seen in the maps sidebar 2705. Each robot on the map is shown in a list along with important information and tools for that robot. These tools and information are also accessible to the user in the maps popup 2710 by clicking on the robot icon directly on the map 106. The maps popup 2710 comprises the task status 2715, the task ID 2720, the current action 2725, the power level 2730, the network level 2735, a maps configuration button 2740, a magnet icon 2745, a “Send to Location” tool 2750, a “show sensor data” button 2755, a “Reset Location” button 2760, a robot schedule 2765, and a robot task 2770. For example, the power level 2730 comprises a battery level. For example, the network level 2735 comprises a WiFi level.

The user can click on the magnet icon 2745, thereby focusing the map view on that robot. If the robot is moving around the map 106, this is a useful alternative to panning the map 106 manually. The user can use the “Send to Location” tool 2750 to click anywhere on the map 106 and the robot will autonomously navigate to that location. To see sensor data of the robot, the user clicks the “show sensor data” button 2755. The user can click on a “show sensor data” button 2755 to turn on two-dimensional (2D) laser data to see the obstacles that a robot is currently sensing in the facility on the map 106. When a robot is navigating, a user clicks on the “show sensor data” button 2755 to turn on a route visualization on the map 106 that depicts the route the robot plans to take to get to the destination. The user can click on the “show sensor data” button 2755 to turn on RFID data to reveal the RFID tags that the robot senses in the facility on the map 106.

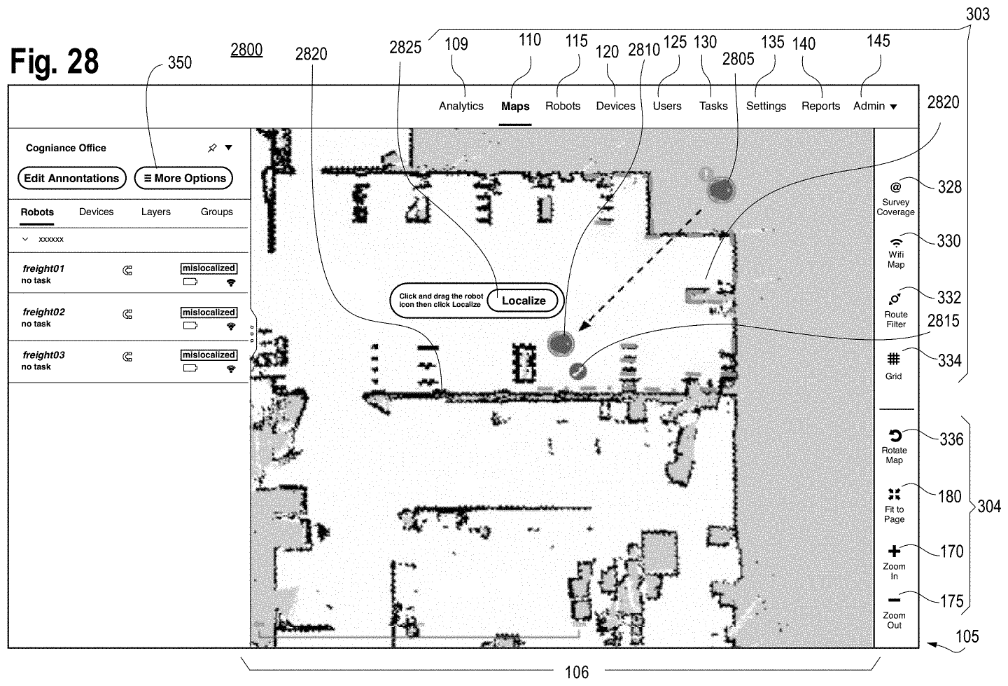

When a robot is mislocalized, it is essentially lost and senses that is in a different location on the map 106 than its actual location. The user can relocalize the robot using the “Reset Location” button 2760 so the system will inform the robot of its accurate location on the map 106. When the user activates the “Reset Location” button 2760, the system opens Reset Location Mode, shown in more detail in FIG. 28 below. The user can add one or more of the robot schedule 2765 and the robot task 2770 directly from the maps popup 2710 as well.

FIG. 28 is a wireframe of the Reset Location page 2800 for the robot management system. If the user selects the “Reset Location” button 2760 on the mapping page 2700 as shown in FIG. 27, the system takes the user to the Reset Location page 2800.

The Reset Location page 2800 again comprises the robots 101, the Analytics tab 109, the Maps tab 110, the Robots tab 115, the Devices tab 120, the Users tab 125, the Tasks tab 130, the Settings tab 135, the Reports tab 140, and the Admin tab 145, the “Exit Edit Mode” button 348, and the “More Options” button 350. The Reset Location page 2800 comprises a screenshot of the map 106 of the facility 102 with a robot. To reset a location of the robot, the user performs a click and drag operation of the robot icon 2805 to drag the robot to a correct location 2810 on the map 106. The user ensures that the robot is facing the correct direction by rotating the robot with the rotation arrow 2815. The laser data of the robot appears on the map 2820 so that the user can align what the robot is “seeing” with mapped features. For example, if the robot is currently facing a wall, the user would move the robot icon 2810 to that position and use a rotate tool 2815 to align the straight laser data with the straight wall on the map 106. Then the system invites the click a “Localize” button 2825.

FIG. 29 is a wireframe of an Analytics page 2900 for the robot management system. If the user selects the Analytics tab 109 on the home page 100 as shown in FIG. 1, the system takes the user to the Analytics page 2900.

The Analytics page 2900 again comprises the Analytics tab 109, the Maps tab 110, the Robots tab 115, the Devices tab 120, the Users tab 125, the Tasks tab 130, the Settings tab 135, the Reports tab 140, and the Admin tab 145. The Analytics page 2900 further comprises an Overview section 2910, an Activity section 2912, an Overview subtab 2915, and a Virtual Conveyor subtab 2920.

The Overview section 2910 comprises a “Days Active” legend 2925, a “Deliveries to Date” legend 2930, a “Distance Traveled” legend 2935, and a robot number legend 2940.

The Activity section 2912 comprises a Working section 2950, an Idle section 2955, a Charging section 2960, an Offline section 2965, an Error section 2970, a status-based robot listing section 2975, and a “View in Map” button 2980.

The Overview section 2910 comprises a user-friendly overview of the robot management system. The Overview section 2910 offers aggregated key metrics and top-level information about the fleet. These key metrics includes the number of days this system has been active 2925, the total number of deliveries the robots 101 in the system have completed to date 2930, the total distance the robots 101 in the system have travelled to date 2935, and the number of the robots 101 that are connected to the system 2940.

The Activity section 2912 offers a real-time snapshot of all the robots 101 in the system and their statuses. The activity section contains five subsections that represent robot statuses, the Working section 2950, the Idle section 2955, the Charging section 2960, the Offline section 2965, and the Error section 2970. The Working section 2950 comprises a list of the robots 101 that are currently working on tasks. As depicted, the Working section 2950 currently comprises two tasks, a first task 3012A having a first task ID 2972A, and a second task 3012B having a second task ID 2972B. The first task ID 2972A comprises 146605. The second task ID 2972B comprises 146852. If the user wishes to view one or more of a status and a progress of the task 3012A-3012B on which the robot is working, the user clicks the task ID 2972A-2972B, which will then take the user to the Activity sub-menu 2212 on the tasks page 2200 (see FIG. 26).

The Idle section 2955 lists the robots 101 that are not assigned to any tasks 3012A-3012B. These robots 101 can be assigned a new task 3012A-3012B if customers want to maximize utilization.

The status-based robot listing section 2975 lists all robots 101 that have that status. The status-based robot listing section 2975 for a status of interest can be opened by clicking on a tab 2950, 2955, 2960, 2964, 2970 corresponding to that robot status. Along with the robot ID and robot status, the status-based robot listing section 2975 comprises one or more of power level and connectivity. If the user wishes to see where a robot is located on the map of their facility, the user clicks the “View in Map” button 2980 to navigate to the home page 100 (FIG. 1). This information is available on all status tabs except the Error section 2970.

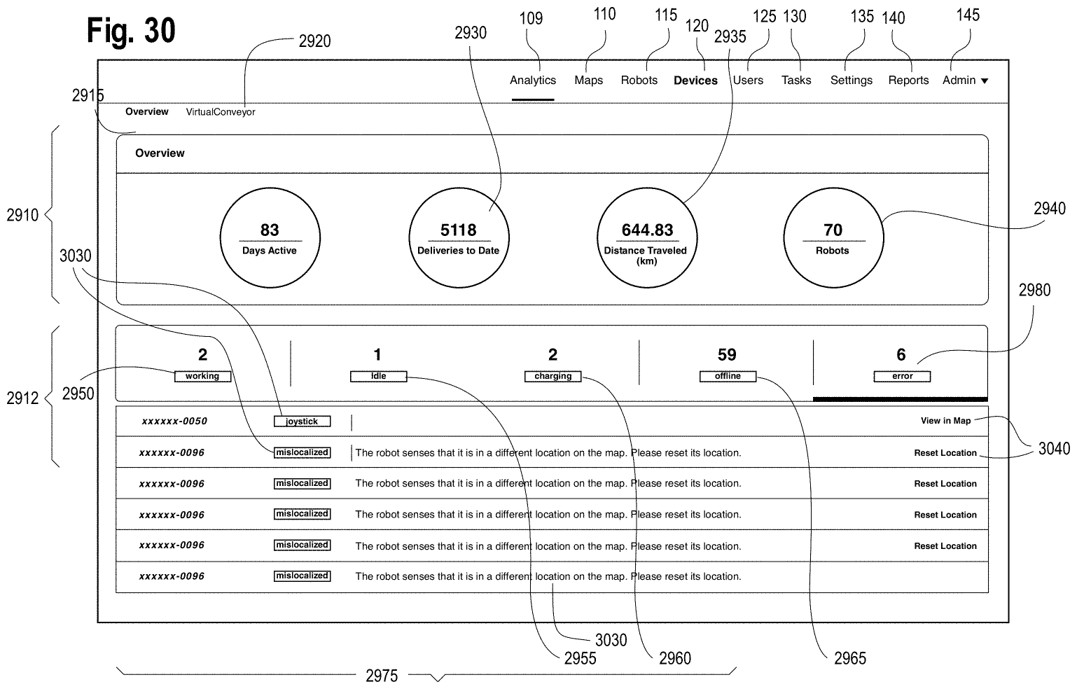

FIG. 30 is a wireframe of an Analytics Error page 3000 for the robot management system. If the user selects the Error tab 2970 on the Analytics page 2900 as shown in FIG. 29, the system takes the user to the Analytics Error page 3000.

The Analytics Error page 3000 again comprises the Analytics tab 109, the Maps tab 110, the Robots tab 115, the Devices tab 120, the Users tab 125, the Tasks tab 130, the Settings tab 135, the Reports tab 140, the Admin tab 145.

The Analytics Error page 3000 again comprises the Overview section 2910, the Activity section 2912, the Overview subtab 2915, the Virtual Conveyor subtab 2920, the “Days Active” legend 2925, the “Deliveries to Date” legend 2930, the “Distance Traveled” legend 2930, the robot number legend 2940, the Working section 2950, the Idle section 2955, the Charging section 2960, the Offline section 2965, and the Error section 2970. The user has selected the error section 2970, so accordingly the status-based robot listing section (item 2975 in FIG. 29) comprises an error status robot listing section 3010.

The Analytics Error page 3000 further comprises a specific error status type 3520, a text information about error 3030, and a “View in Map/Reset Location” link 3040. To provide a streamlined user experience, the Analytics Error page 3000 allows the user to quickly see any robots 101 that are in an error state and require intervention. Shown again is the Error section 2970. The Analytics Error page 3000 comprises the error status robot listing section 3510, the specific error status type 3020, text information about the error 3030. If the user is driving the robot with a controller, the robot is in joystick mode. The “View in Map/Reset Location” link 3040 allows the user to see where the robot is located on the map 106. If the robot is mislocalized, when a user selects the “View in Map/Reset Location” link 3040, the system opens the “Reset Location” page 2800 where the user can reset the location of the robot (described above in FIG. 28).

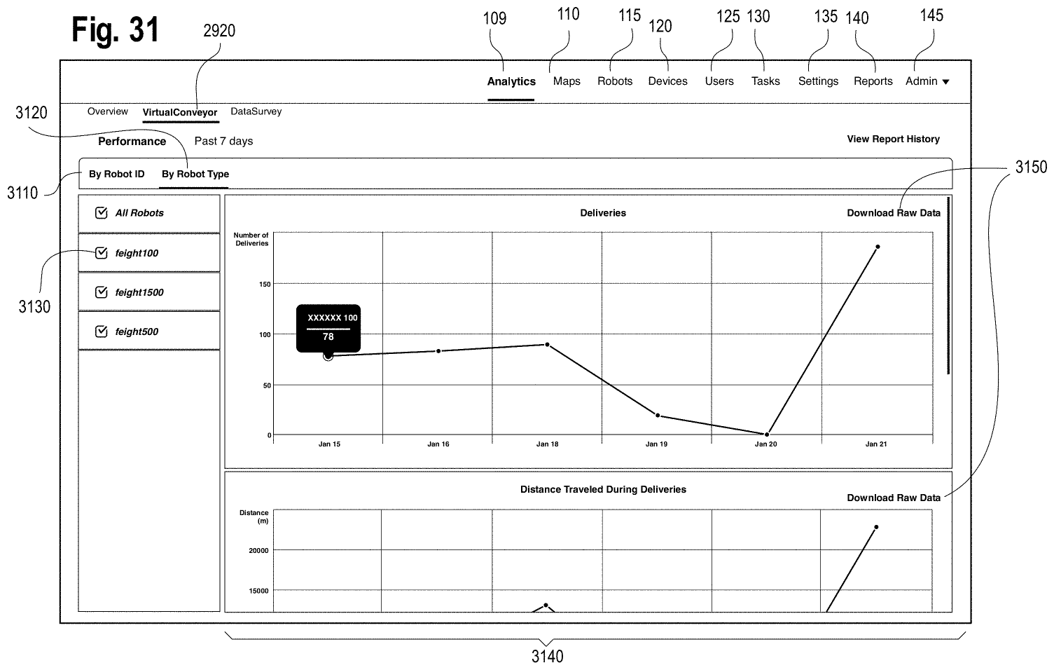

FIG. 31 is a wireframe of a Virtual Conveyor page 3100 for the robot management system. If the user selects the Virtual Conveyor tab 2920 on the Analytics page 2900 as shown in FIG. 29, the system takes the user to the Virtual Conveyor page 3100.

The Virtual Conveyor page 3100 again comprises the Analytics tab 109, the Maps tab 110, the Robots tab 115, the Devices tab 120, the Users tab 125, the Tasks tab 130, the Settings tab 135, the Reports tab 140, and the Admin tab 145.

On the Virtual Conveyor page 3100, the user can view the robots 101 using one or more of a robot ID option 3120 and a robot type option 3130. In a robot selection window 3140, the user can check an individual robot, can select a group of robots, or can select All Robots.

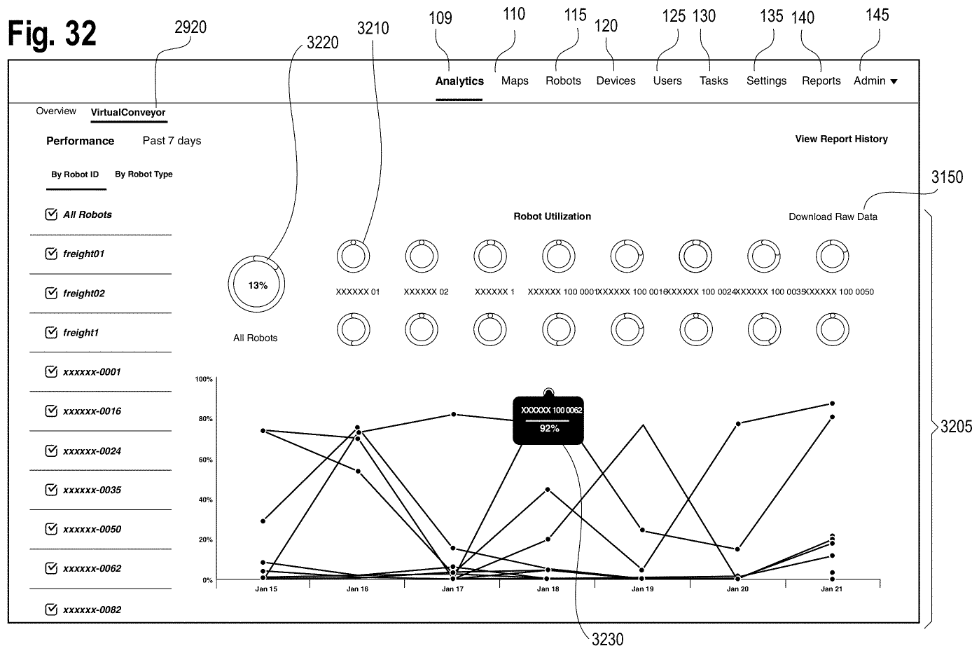

The Virtual Conveyor page 3100 comprises an analytics graph 3150. The analytics graph shows a graphical representation of robot performance in the past seven days including number of deliveries, distance travelled during deliveries, and robot utilization. (The Virtual Conveyor/Analytics page is discussed below in more detail in FIG. 32). As depicted, the analytics graph 3150 comprises a plot of “Number of Deliveries” versus Distance Travelled During Deliveries.”

FIG. 32 is a wireframe of a Virtual Conveyor/Analytics page 3200 for the robot management system. If the user selects the Analytics tab 109 on the home page 100 as shown in FIG. 1, the system sends the user to the Virtual Conveyor/Analytics page 3200.

The Virtual Conveyor/Analytics page 3200 again comprises the Analytics tab 109, the Maps tab 110, the Robots tab 115, the Devices tab 120, the Users tab 125, the Tasks tab 130, the Settings tab 135, the Reports tab 140, and the Admin tab 145.

On the Virtual Conveyor/Analytics page 3200, the user can view the robots 101 using one or more of a robot ID option 3120 and a robot type option 3130. In a robot selection window 3140, the user can check an individual robot, can select a group of robots, or can select “All Robots.”

The Virtual Conveyor/Analytics page 3200 comprises analytics graphs 3205. The analytics graph shows a graphical representation of robot utilization 3220 for all robots, of robot utilization 3220 for specific robots, and of robot utilization over time 3230. The system considers that a robot is being utilized when it has a status of working. The system considers that a robot is not being utilized when it has a status of idle, error, or offline. The system invites the user to download the graphically represented data by clicking on the Download Raw Data link 3150.

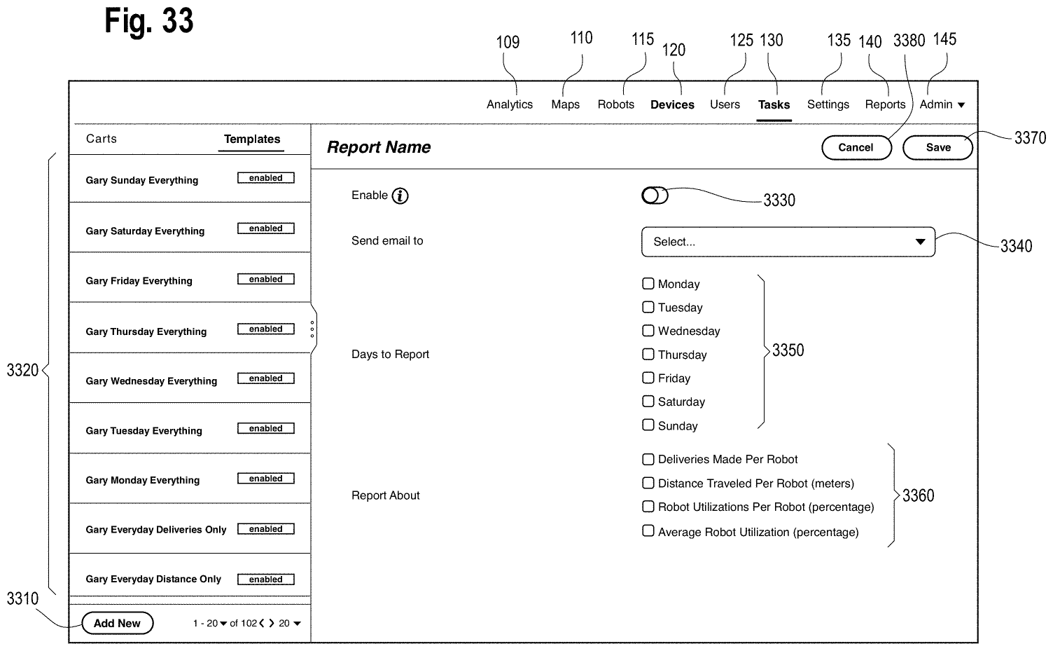

FIG. 33 is a wireframe of a Reports page 3300 for the robot management system. The Reports page 3300 again comprises the map 106, the facility 102, the Analytics tab 109, the Maps tab 110, the Robots tab 115, the Devices tab 120, the Users tab 125, the Tasks tab 130, the Settings tab 135, the Reports tab 140, and the Admin tab 145.

If the user selects the Reports tab 140 on the home page 100 as shown in FIG. 1, the system sends the user to the Reports page 3300. The Reports page 3300 allows the user to create automatic electronic mail (email) reports containing information about their robot fleet performance. The Reports page comprises a new report button 3310, a report list 3320, a toggle 3330 to enable or disable the report, an email recipient field 3340, a checklist 3350 of days of the week to include in the report, a checklist of robot performance metrics 3360 to include in the report, a save new report button 3370, and a cancel new report button 3380. Once all fields are filled out, the user click the new report save button 3370, after which the system adds the new report to the report list 3320. Alternatively, or additionally, the user clicks the cancel new report button 3380 to cancel creation of the new email report. The system sends enabled email reports to the email recipients on a weekly basis.

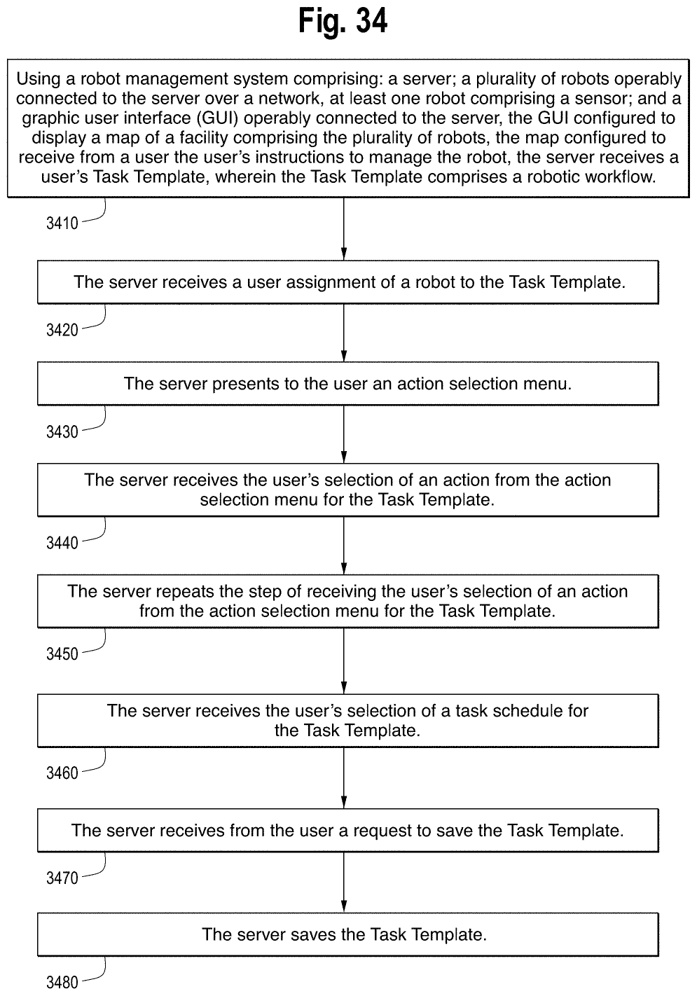

FIG. 34 is a flow chart of a method 3400 for robot management, more specifically for creating a Task Template using the system for robot management.

The order of the steps in the method 3400 is not constrained to that shown in FIG. 34 or described in the following discussion. Several of the steps could occur in a different order without affecting the final result.

In step 3410, using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, the server receives a user's Task Template, wherein the Task Template comprises a robotic workflow. Block 3410 then transfers control to block 3420.

In step 3420, the server receives a user assignment of a robot to the Task Template. Block 3420 then transfers control to block 3430.

In step 3430, the server presents to the user an action selection menu. Block 3430 then transfers control to block 3440.

In step 3440, the server receives the user's selection of an action from the action selection menu for the Task Template. Block 3440 then transfers control to block 3450.

In step 3450, the server repeats the step of receiving the user's selection of an action from the action selection menu for the Task Template. Block 3450 then transfers control to block 3460.

In step 3460, the server receives the user's selection of a task schedule for the Task Template. Block 3460 then transfers control to block 3470.

In step 3470, the server receives from the user a request to save the Task Template. Block 3470 then transfers control to block 3480.

In step 3480, the server saves the Task Template. Block 3480 then terminates the process.

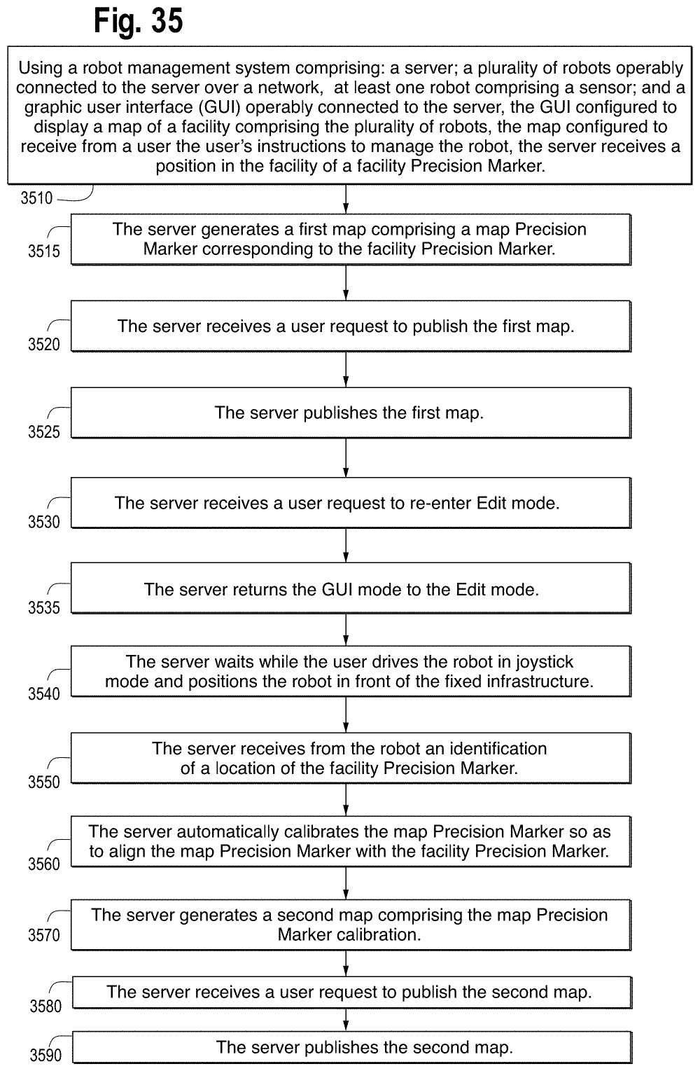

FIG. 35 is a flow chart of a method 3500 for robot management, more specifically for automatic robotic calibration of a Precision Marker.

The order of the steps in the method 3500 is not constrained to that shown in FIG. 35 or described in the following discussion. Several of the steps could occur in a different order without affecting the final result.

In step 3510, using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, the server receives a position in the facility of a facility Precision Marker. Block 3510 then transfers control to block 3515.

In step 3515, the server generates a first map comprising a map Precision Marker corresponding to the facility Precision Marker. Block 3515 then transfers control to block 3520.

In step 3520, the server receives a user request to publish the first map. Block 3520 then transfers control to block 3525

In step 3525, the server publishes the first map. Block 3525 then transfers control to block 3530.

In step 3530, the server receives a user request to re-enter Edit Mode. Block 3530 then transfers control to block 3546.

In step 3535, the server returns the GUI mode to the Edit Mode. Block 3535 then transfers control to block 3540.

In step 3540, the server waits while the user drives the robot in joystick mode and positions the robot in front of the fixed infrastructure. Block 3540 then transfers control to block 3550.

In step 3550, the server receives from the robot an identification of a location of the facility Precision Marker. Block 3550 then transfers control to block 3560.

In step 3560, the server automatically calibrates the map Precision Marker so as to align the map Precision Marker with the facility Precision Marker. Block 3560 then transfers control to block 3570.

In step 3570, the server generates a second map comprising the map Precision Marker calibration. Block 3570 then transfers control to block 3580.

In step 3580, the server receives a user request to publish the second map. Block 3580 then transfers control to block 3590.

In step 3590, the server publishes the second map. Block 3590 then terminates the process.

Optionally, the method further comprises additional steps of: additional steps of: receiving, by the server, from the user, a user selection of the robot from the robot list; receiving, by the server, from the user, a user click on a “Scan Marker” button; and populating values, by the server, of a current alignment of the robot with the facility position of the Precision Marker.

Optionally, the method further comprises additional steps of: receiving, by the server, from the user, an adjustment of the robot alignment; receiving, by the server, from the user, a user click on the “Scan Marker” button; receiving, by the server, repetitions from the user of robot alignment adjustment and of a click on the “Scan Marker” button; and receiving, by the server, from the user, a user click on an “Apply” button accepting validity of the robot alignment.

The Optionally, the method further comprises additional steps of receiving, by the system, a user click of a “Test Alignment” button; computing, by the system, offsets usable by the robot to position itself relative to the Precision Marker; and repositioning the robot, by the server, using the offsets.

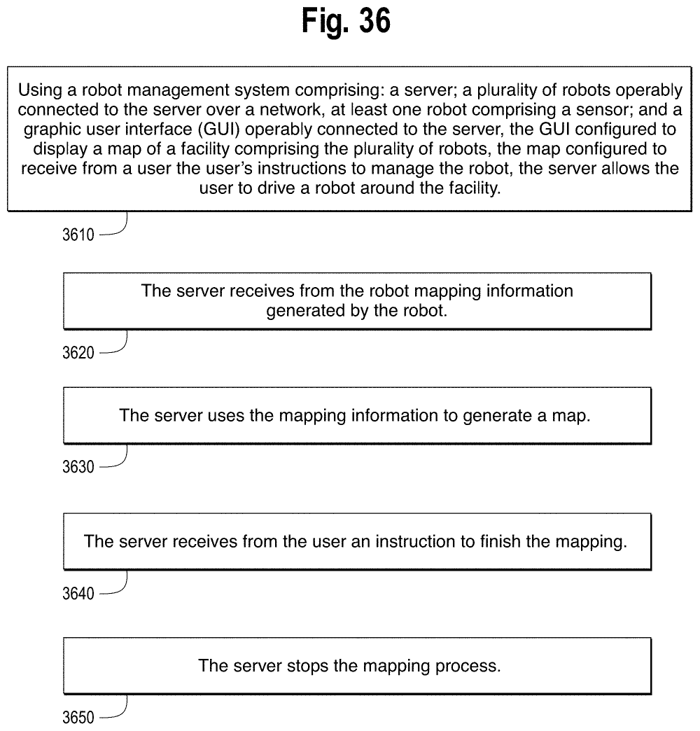

FIG. 36 is a flow chart of a method 3600 for robot management, more specifically for creating a facility map using the system for robot management.

The order of the steps in the method 3600 is not constrained to that shown in FIG. 36 or described in the following discussion. Several of the steps could occur in a different order without affecting the final result.

In step 3610, using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, the server allows the user to drive a robot around the facility. Block 3610 then transfers control to block 3620.

In step 3620, the server receives from the robot mapping information generated by the robot. Block 3620 then transfers control to block 3630.

In step 3630, the server uses the mapping information to generate a map. Block 3630 then transfers control to block 3640.

In step 3640, the server receives from the user an instruction to finish the mapping. Block 3640 transfers control to block 3650.

In step 3650, the server stops the mapping process. Block 3650 then terminates the process.

Optionally, the method comprises an additional step of providing, by the server, the map to a second robot.

Optionally, the method comprises an additional step of providing, by the server, the map to all robots.

An advantage of embodiments of the invention is that the robot management system enables users to remotely and efficiently control a large fleet of robots.

A further advantage of embodiments of the invention is they provide robust management of autonomous mobile robots without a need for any sort of marker to be located in the facility to guide the robot.

A further advantage of embodiments of the invention is that the robot management system facilitates a user in responding easily to changes in one or more of a facility's layout and a user's needs. An additional advantage of embodiments of the invention is that the robot management system enables users to change robot workflows easily. A further advantage of embodiments of the invention is that the robot management system allows user changes in a robot workflow to become effective immediately.

A yet additional advantage of embodiments of the invention is that the robot management system gathers in-depth analytics that inform users of the performance of not only their robot fleet, but also the human workers in their facility. A still further advantage of embodiments of the invention is that the robot management system enables users to understand one or more of product flow and traffic patterns. Another advantage of embodiments of the invention is that the robot management system enables users to increase efficient use of information gathered by robots.

Advantages of embodiments of the invention include allowing a user to quickly set up and deploy the robots. The intuitive interface allows a user to quickly modify one or more of existing tasks, schedules maps, robots, and users as one or more of a change in workflow and a change in the facility. Embodiments of the invention allow a use to do one or more of create a very specific workflow, instruct a robot as to a current location of the robot, and instruct a robot regarding a desired destination.

Another advantage of embodiments of the invention is that the robot management system facilitates collaboration among multiple users by supporting multiple users to edit the same map at the same time. Yet another advantage of embodiments of the invention is that the Required Route toggle button when selected by the user requires the robot to strictly follow the Preferred Route during autonomous navigation and not travel in the opposite direction on the route, which is useful for traffic management in scenarios with many robots traveling in the facility.

Another advantage of embodiments of the invention is that the overlay that shows estimated sensor coverage allows the user to easily place the data Survey Route so the robotic sensor can read the RFID tag by maximizing the displayed estimated sensor coverage.

Another advantage of embodiments of the invention is that the ability the system offers for the user to set directionality of a robotic destination enables the user to accommodate one or more of a destination in a tight space and a destination in a busy location.

Yet another advantage of embodiments of the invention is that the Charging Dock Annotation Tool allows a robot to know a location of a physical charging dock in the facility and further allows the robot to use the location to autonomously navigate to the charging dock for charging of its power source. Another advantage of embodiments of the invention is that the Cart Transfer Location Tool allows a robot to know a location of a cart transfer station in the facility and further allows the robot to use the Cart Transfer Location to autonomously navigate to the Cart Transfer Location. Another advantage of embodiments of the invention is that the size of the Cart Transfer Location icon corresponds to a size of the cart transfer area needed for the cart transfer, thereby enabling the user to accurately place Cart Transfer Locations. Still another advantage of embodiments of the invention is that the Cart Transfer Location perimeter allows the user to know how much space is needed to keep clear of obstacles in the facility and to effect a transfer of carts.

Still another advantage of embodiments of the invention is that the joystick mode toggle requires a user click to resume autonomous operation, thereby improving safety of operating robots. This safety feature also ensures that the user knows when robots are going to resume autonomous navigation.

Yet another advantage of embodiments of the invention is that since efficiency and utilization are central to customers in the warehousing and logistics market, the Idle section feature allows the user to quickly identify idle robots and re-allocate work to them.

Still another advantage of embodiments of the invention is that the system by providing the user with both the rectangle tool and the polygon tool accommodates a broad variety of user needs. The rectangle tool is useful for large, square map areas and lets the user click and drag to draw the area, while the polygon tool allows the user to get more precise with an irregularly shaped area that they can click and draw along a wall rather than having to create a number of smaller rectangular areas.

Still a further advantage of embodiments of the invention is that the completed task template comprises action blocks that make it simple and efficient for a user to build robotic workflows.

Still another advantage of embodiments of the invention is that the system, by providing the user with performance statistics of a robot fleet, enables users to draw insights about their operations. The invention provides real insights. For example, the number of deliveries a robot is making is directly related to the number of deliveries that humans are picking and loading on the robot. In addition, the distance travelled by a robot directly relates to the distance a human did not have to travel. In addition, the robot utilization information informs the user how floor associates are using the robots.

Still another advantage of embodiments of the invention is that the system enables users to change robotic workflows immediately and effectively. A user is able to change any element of the task template, for example adding a destination option or increasing the time a robot waits at a location or automating a cart transport flow so no humans need to summon the robots.

It will be obvious to one skilled in the art that the server can be located in a variety of places. For example, the server may be a server located within or adjacent to the facility in which one or more robots operate. For example, the server may be located in the cloud. For example, the server may be the computer that is building the map. For example, the server may be a computer that is part of an autonomous agent. For example, the server may be the primary computer in the autonomous agent.

It will be understood by those skilled in the art that software used by the robot management system and graphic user interface may be located in any location in which it may be accessed by the system. It will be further understood by those of skill in the art that the number of variations of the network, the location of the software, and the like are virtually limitless. For example, the number of users creating the map is unlimited. For example, the number of robots driven by the users in creating the map is similarly unlimited. For example, variations are possible in which two users drive the same robot. For example, variations are possible in which the user drives two or more robots, and the like.

For example, the system may comprise only one robot. For example, the minimum speed of travel in a Speed Limit Zone may apply only to certain robots. For example, the maximum speed of travel in the Speed Limit Zone may apply only to certain robots. For example, the minimum speed of travel in the Speed Limit Zone may apply to different robots than the robots to which the maximum speed of travel applies in the Speed Limit Zone.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

1. A robot management system comprising:
a server;
a plurality of robots operably connected to the server over a network, at least one robot comprising a sensor; and
a graphic user interface (GUI) operably connected to the server, the GUI configured to display a map of a facility comprising the plurality of robots, the map configured to receive from a user the user's instructions to manage the robot, wherein the system is configured to create the map of the facility, wherein the system is further configured to allow the user to create the map by driving a first robot around the facility.

2. (canceled)

3. The robot management system of claim 2, wherein the map shows robot activity in real time.

4. The robot management system of claim 2, wherein the system is configured to respond to a user click on a robot by showing one or more of settings of the robot and tools usable on the robot.

5. The robot management system of claim 2, wherein the system presents the user with a “Send to Location” tool to command the robot to autonomously navigate to a location.

6. The robot management system of claim 2, wherein the system presents the user with a tool usable to reset a location of a robot.

7. The robot management system of claim 2, wherein the system is configured, while displaying the map, to respond to a user click on a robot by displaying analytic information regarding the robot.

8. The robot management system of claim 2, wherein the system is configured, while displaying analytic information, to respond to a user click on a “a view in map” option for a robot by displaying the selected robot in the map.

9. (canceled)

10. The robot management system of claim 9, wherein the system is configured to receive from the user an instruction to finish the mapping when the user deems the mapping completed.

11. The robot management system of claim 10, wherein a second robot uses the map created by the user driving the first robot.

12. The robot management system of claim 10, wherein all robots of a same base type use the map created by the user driving the first robot.

13. The robot management system of claim 1, the GUI comprising a Maps page usable by the user to help robots autonomously navigate around the facility.

14. The robot management system of claim 13, the Maps page comprising sub-menus for one or more of robots, devices, layers, and groups.

15. The robot management system of claim 1, the system configured, using the GUI, to allow the user to do one or more of create a robotic workflow, schedule a robotic workflow, change a robotic workflow, add a robotic station, remove a robotic station, add a Preferred Route, remove a Preferred Route, add a disfavored route, remove a disfavored route, add a traffic rule, remove a traffic rule, add a Keepout Zone, remove a Keepout Zone, add an Obstacle-Free Area, remove an Obstacle-Free Area, distribute a robotic task, modify the task, schedule the task, modify a robotic schedule, modify the robot, and modify the user.

16. The robot management system of claim 15, wherein the change in robotic workflow becomes effective immediately.

17. The robot management system of claim 16, wherein the system receives the change in robotic workflow from the user by allowing the user to use the robot to do one or more of build the map and annotate the map in accordance with the change in robotic workflow.

18. The robot management system of claim 17, wherein the system enables the user to incorporate the change by driving the robot around the facility so as to update the map.

19. The robot management system of claim 1, the GUI further comprising a robots menu configured to receive from the user a characteristic of the robot.

20. The robot management system of claim 19, wherein the robots menu comprises one or more of a robots option, a current status of robots, tasks assigned to robots, a connectivity strength, an energy level, a joystick mode toggle to start or stop autonomous operation of a robot, a task type, a unique task ID, and robot settings.

21. The robot management system of claim 20, wherein the robot settings comprise one or more of a robot configuration, a robot footprint, a robotic map update, a robotic map icon, and a robotic options menu.

22. The robot management system of claim 21, wherein the robot configuration comprises one or more of a type of robot base and a type of robot attachment.

23. The robot management system of claim 21, wherein the robot footprint comprises one or more of a size of the robot, a footprint of the robot, a size of a robotic attachment, and a footprint of a robotic attachment.

24. The robot management system of claim 21, wherein the robotic map update allows the user to assign the robot to a map.

25. The robot management system of claim 1, the GUI further comprising a tasks menu configured to receive from the user a robot task.

26. The robot management system of claim 25, wherein the tasks menu comprises a sub-menu for one or more of task history, task schedules, and task templates.

27. The robot management system of claim 1, the GUI further comprising a settings menu configured to receive from the user a setting of the robot.

28. The robot management system of claim 27, wherein the settings menu comprises a sub-menu for one or more of charge management settings, robot settings, stage management settings, human machine interface (HMI) display settings, and general settings.

29. The robot management system of claim 1, the GUI further comprising a Reports menu configured to receive from the user a report regarding a robot.

30. The robot management system of claim 29, wherein the Reports menu shows a report template, the report template configured to allow the user to create a report about a robot.

31. The robot management system of claim 30, wherein the report comprises performance statistics regarding the robot.

32. The robot management system of claim 30, wherein the system automatically generates the report created by the user about the robot.

33. The robot management system of claim 15, wherein the traffic rule applies to the robot as the robot travels around the facility.

34. The robot management system of claim 33, wherein the traffic rule comprises one or more of a Speed Limit Zone and a right of way.

35. The robot management system of claim 34, wherein the Speed Limit Zone comprises an area in which the system, instructs the robot that it has one or more of a minimum speed of travel and a maximum speed of travel.

36. The robot management system of claim 35, wherein the system instructs the robot based on one or more of a system default, a system algorithm, and a user instruction.

37. The robot management system of claim 1, wherein the system is configured to allow the user to do one or more of configure a robot and monitor a robot.

38. The robot management system of claim 2, wherein the system is configured to allow a user to enter Edit Mode, the system further configured to receive a map annotation from the user.

39. The robot management system of claim 38, wherein the system receives a map annotation submitted by the user clicking on the map at an appropriate location where the user desires to place the map annotation.

40. The robot management system of claim 39, wherein the system is further configured to alter the map in accordance with the user's map annotation.

41. The robot management system of claim 39, wherein the system is configured to provide the user with map Annotation Tools.

42. The robot management system of claim 41, wherein the map Annotation Tools comprise one or more of a Preferred Route, a Survey Route, a Robot Destination, a Keepout Zone, a Speed Limit Zone, an Obstacle-Free Area, a Charging Dock, a Cart Transfer, a Precision Marker, a Text Label, a Show Survey Coverage, a WiFi Map, a Route Filter, and a Show Grid.

43. The robot management system of claim 42, wherein the Preferred Route comprises one or more of information pertaining to a Preferred Route for a robot and information pertaining to a Preferred Route for a cart.

44. The robot management system of claim 42, wherein the Preferred Route comprises a route preferred by the user for a robot in navigating around the facility.

45. The robot management system of claim 44, wherein the system receives from the user a user designation of a directionality of the Preferred Route as one or more of a unidirectional Preferred Route and a bidirectional Preferred Route.

46. The robot management system of claim 45, wherein the bidirectional Preferred Route permits the robot to travel on it in both directions.

47. The robot management system of claim 45, wherein the unidirectional Preferred Route permits the robot to travel on it only in one direction.

48. The robot management system of claim 45, wherein the system determines the directionality of the Preferred Route using one or more of a system default, a system algorithm, and a user instruction.

49. The robot management system of claim 42, wherein the system receives from the user the Preferred Route by receiving from the user a user click on the map indicating a location of the Preferred Route.

50. The robot management system of claim 49, wherein the system receives from the user the Preferred Route by further receiving from the user the user's drawing of the Preferred Route.

51. The robot management system of claim 42, wherein the Preferred Route further comprises Preferred Route settings.

52. The robot management system of claim 51, wherein the Preferred Route setting comprise one or more of a Required Route, a Route Priority, a Route Access, a robot permission, and a Preferred Route overlay.

53. The robot management system of claim 52, wherein the Required Route requires the robot to strictly follow the Preferred Route while autonomously navigating.

54. The robot management system of claim 53, wherein the Required Route further required the robot during autonomous navigation not to travel in an opposite direction on the Preferred Route.

55. The robot management system of claim 52, wherein the Route Priority receives from the user the user's designation of a route priority of the Preferred Route.

56. The robot management system of claim 55, wherein the Route Priority comprises one or more of low, normal, and high.

57. The robot management system of claim 55, wherein a robot traveling on the high priority route has a right of way at intersections relative to a robot traveling on a route that is not high priority.

58. The robot management system of claim 53, wherein the route Access receives from the user a designation by the user of one or more of a type of robot authorized to travel on the Preferred Route and a type of cart authorized to travel on the Preferred Route.

59. The robot management system of claim 58, wherein the system is configured to receive from the user adding the Preferred Route a user selection of one or more of a robot allowed to access the Preferred Route, and a cart allowed to access the Preferred Route.

60. The robot management system of claim 43, wherein the Obstacle-Free Area comprises an area free of obstacles that interfere with the robot's navigation.

61. The robot management system of claim 43, wherein the Show Survey Coverage provides a Coverage overlay to the map showing an estimated coverage region of the sensor of the robot while traveling on a data Survey Route on which a data survey robot collects data.

62. The robot management system of claim 43, wherein the WiFi Map provides a WiFi overlay to the map showing an estimated connectivity strength of a WiFi network.

63. The robot management system of claim 62 wherein the system creates the WiFi overlay using data collected by the robot during creation of the map.

64. The robot management system of claim 43, wherein the Route Filter provides a Route Filter overlay to the map showing a route that is prohibited for one or more of a selected robot and a selected cart.

65. The robot management system of claim 39, wherein the system is configured to mark a new annotation if the new annotation conflicts with an existing map annotation.

66. The robot management system of claim 65, wherein the system is configured to mark the new annotation is red if the new annotation conflicts with the existing annotation.

67. The robot management system of claim 39, wherein the system is configured to simultaneously receive a first annotation from a first user and a second annotation from a second user.

68. The robot management system of claim 67, wherein the first user sees the second user's second annotation after the first user exits Edit Mode.

69. The robot management system of claim 1, wherein the sensor comprises a radio frequency identification (RFID) sensor.

70. The robot management system of claim 61, the GUI comprising a Survey Route Annotation Tool.

71. The robot management system of claim 70, wherein the Survey Route Annotation Tool is usable by the user to configure a Survey Route on which a data survey robot collects data.

72. The robot management system of claim 71, wherein the Coverage overlay allows the user to see a system estimate of coverage of the data Survey Route by the sensor.

73. The robot management system of claim 71, wherein the system receives a Survey Route point submitted by the user clicking on the map at an appropriate location where the user desires to place the Survey Route point, the Survey Route comprising the Survey Route point.

74. The robot management system of claim 73, wherein the system is configured to generate a Survey Route that best fits the Survey Route points.

75. The robot management system of claim 43, wherein, the Robot Destination receives from the user a user click on a Robot Destination type selected by the user.

76. The robot management system of claim 75, wherein the system is configured, after receiving from the user the Robot Destination type, to display on the map a cursor in a form of a Robot Destination icon.

77. The robot management system of claim 76, wherein the system displays a Robot Destination icon comprising a Robot Destination icon size that is scaled to match a size of the robot.

78. The robot management system of claim 77, wherein the system is further configured, after displaying the cursor in the form of the Robot Destination icon, to receive from the user a user click on the map that indicates a position of the Robot Destination.

79. The robot management system of claim 78, wherein the system is further configured, after receiving the position of the Robot Destination from the user, to display on the GUI the Robot Destination.

80. The robot management system of claim 79, wherein the system is further configured to display the Robot Destination using the Robot Destination icon.

81. The robot management system of claim 80, wherein the system receives from the user a user designation of a directionality of the Robot Destination as one or more of a unidirectional Robot Destination and a bidirectional Robot Destination.

82. The robot management system of claim 81, wherein the bidirectional Robot Destination permits the robot to do one or more of enter the Robot Destination moving in either direction and exit the Robot Destination moving in either direction.

83. The robot management system of claim 81, wherein the unidirectional Preferred Route permits the robot to do one or more of enter the Robot Destination moving in only one direction and exit the Robot Destination moving only in a specified direction.

84. The robot management system of claim 81, wherein the system determines the directionality of the Robot Destination using one or more of a system default, a system algorithm, and a user instruction.

85. The robot management system of claim 43, wherein a Keepout Zone comprises an area unavailable to a robot.

86. The robot management system of claim 85, wherein the system receives a Keepout Zone submitted by the user clicking on the map at an appropriate location where the user desires to place the Keepout Zone.

87. The robot management system of claim 85, wherein the Keepout Zone comprises one or more of stairs, shelving, and another object to be avoided by the robot.

88. The robot management system of claim 85, wherein the Keepout Zone applies to one or more of a selected robot, to a selected robot type, and to all robots.

89. The robot management system of claim 88, wherein the system receives the robot selection through one or more of a system default, a system algorithm, and a user designation.

90. The robot management system of claim 43, wherein the Charging Dock comprises an area where an energy level of the robot can be replenished.

91. The robot management system of claim 90, wherein the system receives a Charging Dock submitted by the user clicking on the map at an appropriate location where the user desires to place the Charging Dock.

92. The robot management system of claim 43, wherein the Cart Transfer comprises a Cart Transfer Location where a cart transfer robot can do one or more of pick up a cart and drop off a cart.

93. The robot management system of claim 92, wherein the system receives from the user a user click on the map that indicates the Cart Transfer Location selected by the user.

94. The robot management system of claim 93, wherein the system is configured, after receiving from the user the Cart Transfer Location, to display on the map a cursor in a form of a Cart Transfer Location icon.

95. The robot management system of claim 94, wherein the system displays a Cart Transfer Location icon size that is scaled to match a size of a cart transfer area.

96. The robot management system of claim 95, wherein the cart transfer area comprises a space the robot has in which to perform a cart transfer operation.

97. The robot management system of claim 96, wherein the system is further configured, after receiving the position of the Cart Transfer Location from the user, to display on the GUI the Cart Transfer Location.

98. The robot management system of claim 93, wherein the system further receives from the user one or more of a cart transfer orientation, a cart transfer orientation arrow, a cart transfer area, a cart transfer area perimeter, and a Cart Transfer Location name.

99. The robot management system of claim 43, wherein the Precision Marker Annotation Tool comprises a map position of fixed infrastructure usable by the robot to position itself within a predetermined accuracy limit of the fixed infrastructure.

100. The robot management system of claim 43, where the map position of the fixed infrastructure reflects a position in the facility of a Precision Marker that marks the fixed infrastructure.

101. The robot management system of claim 99, wherein the fixed infrastructure comprises one or more of a conveyor belt, a shelf, a wall, an arm of a stationary robot, a door, an elevator, and another fixed infrastructure.

102. The robot management system of claim 100, wherein the system receives from the user a user click on the map that indicates the infrastructure map position designated by the user.

103. The robot management system of claim 102, wherein the system is further configured, after receiving the infrastructure map position from the user, to display on the GUI the infrastructure map position.

104. The robot management system of claim 103, where the Precision Marker Annotation Tool configures one or more offsets usable by the robot to position itself relative to the Precision Marker.

105. The robot management system of claim 104, wherein the offsets comprise offsets in one or more of a horizontal x direction, a horizontal y direction that is orthogonal to the horizontal x direction, and a theta offset indicating an angle at which the robot approaches the Precision Marker.

106. The robot management system of claim 105, wherein the system receives a user calibration of one or more offset.

107. The robot management system of claim 106, wherein the system receives the user calibration by one or more of receiving manually entered values from the user and performing automatic calibration in conjunction with the robot.

108. The robot management system of claim 107, wherein the Precision Marker Annotation Tool further comprises a “Scan Marker” button configured to provide a current alignment of the robot with the Precision Marker.

109. The system of claim 26, wherein the system uses the task templates sub-menu to receive from a user instructions to create a task template for a robot designated by the user.

110. The system of claim 109, wherein the task template comprises a robot workflow, the robot workflow comprising one or more robot tasks.

111. The system of claim 110, wherein a task comprises a sequence of one or more actions that the system receives from a user that the user instructed the robot to perform.

112. The system of claim 111, wherein the action comprises one or more of a Go to Destination Action, a Wait for Destination Selection Action, a Wait for Button Press Action, a Play Sound Action, a Wait at Destination Action, a Charge Action, a Survey Action, a Connect to Cart Action, a Precision Alignment Action, and a Trigger Device Action.

113. The robot management system of claim 112, wherein the Go to Destination Action sends the robot to a specific destination in the facility.

114. The robot management system of claim 112, wherein the Charge Action sends the robot to replenish energy level at an available Charging Dock for one or more of a defined charge period and a defined energy level.

115. The robot management system of claim 112, wherein the Survey Action comprises activation of the robotic sensor navigation by a data survey robot along a Data Survey Route.

116. The robot management system of claim 112, wherein the Precision Alignment Action comprises navigation by the robot to the Precision Marker and alignment of the robot with the Precision Marker.

117. The robot management system of claim 112, wherein the Trigger Device Action comprises interaction by the robot with a device the user has configured and performance by the robot of a user-designated action.

118. The robot management system of claim 109, wherein the system receives a user selection of a task schedule for the task template.

119. The robot management system of claim 118, wherein the task schedule the system receives from the user comprises one or more of a task start date, a task frequency, a task time range, a task repetition frequency, task valid days, a task repetition period, and a task repetition end.

120. The robot management system of claim 109, wherein robot settings comprise a preemption button.

121. The robot management system of claim 120, wherein the preemption button allows the system to receive from a user a designation that an action can be interrupted by another task.

122. The robot management system of claim 121, wherein the preemption button comprises options of never, if assigned task is available, and if any task is available.

123. A method for robot management, comprising:
using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, receiving, by the server, a user's Task Template, wherein the Task Template comprises a robotic workflow;
receiving, by the server, a user assignment of a robot to the Task Template;
presenting, by the server, to the user, an action selection menu for the Task Template;
receiving, by the server, the user's selection of an action from the action selection menu for the Task Template;
repeating, by the server, the step of receiving the user's selection of an action from the action selection menu for the Task Template;
receiving, by the server, the user's selection of a a task schedule for the Task Template;
receiving, by the server, from the user a request to save the Task Template; and
saving, by the server, the Task Template.

124. The method for robot management of claim 123, wherein the task schedule the server receives from the user comprises one or more of a task start date, a task frequency, a task time range, a task repetition frequency, task valid days, a task repetition period, and a task repetition end.

125. A method for robot management, comprising:
using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, receiving, by the server, a position in the facility of a facility Precision Marker;
generating, by the server, a first map comprising a map Precision Marker corresponding to the facility Precision Marker;
receiving, by the server, a user request to publish the first map;
publishing, by the server, the first map;
receiving, by the server, a user request to re-enter Edit Mode;
returning, by the server, the GUI mode to the Edit Mode;
waiting, by the server, while the user drives the robot in joystick mode and positions the robot in front of the fixed infrastructure;
receiving, by the server, from the robot an identification of a location of the facility Precision Marker;
automatically calibrating, by the server, the map Precision Marker so as to align the map Precision Marker with the facility Precision Marker;
generating, by the server, a second map comprising the map Precision Marker calibration;
receiving, by the server, a user request to publish the second map; and
publishing, by the server, the second map.

126. The method for robot management of claim 125, further comprising additional steps of:
receiving, by the server, from the user, a user selection of the robot from the robot list;
receiving, by the server, from the user, a user click on a “Scan Marker” button; and
populating values, by the server, of a current alignment of the robot with the facility position of the Precision Marker.

127. The method for robot management of claim 126, further comprising additional steps of:
receiving, by the server, from the user, an adjustment of the robot alignment;
receiving, by the server, from the user, a user click on the “Scan Marker” button;
receiving, by the server, repetitions from the user of robot alignment adjustment and of a click on the “Scan Marker” button; and
receiving, by the server, from the user, a user click on an “Apply” button accepting validity of the robot alignment.

128. The method for robot management of claim 126, further comprising additional steps of:
receiving, by the system, a user click of a “Test Alignment” button;
computing, by the system, offsets usable by the robot to position itself relative to the Precision Marker; and
repositioning the robot, by the server, using the offsets.

129. A method for robot management, comprising:
using a robot management system comprising: a server; a plurality of robots operably connected to the server over a network, at least one robot comprising a sensor; and a graphic user interface (GUI) operably connected to the server, the GUI configured to display a map of a facility comprising the plurality of robots, the map configured to receive from a user the user's instructions to manage the robot, allowing a user, by the server, to drive a robot around the facility;
receiving, by the server, from the robot mapping information generated by the robot;
generating a map, by the server, using the mapping information;
receiving, by the server, from the user, an instruction to finish the mapping; and
stopping the mapping, by the server, wherein the system is configured to create the map of the facility, wherein the system is further configured to allow the user to create the map by driving a first robot around the facility.

130. The method for robot management of claim 129, comprising an additional step of:
providing, by the server, the map to a second robot.

131. The method for robot management of claim 129, comprising an additional step of:
providing, by the server, the map to all robots.
